(19) United States
(12) Patent Application Publication
(10) Pub. No.: US 2025/0013006 A1
(43) Pub. Date: Jan. 9, 2025

(54) OPTICAL SYSTEM, OPTICAL APPARATUS, AND METHOD FOR MANUFACTURING OPTICAL SYSTEM

(71) Applicant: NIKON CORPORATION, Tokyo (JP)

(72) Inventors: Ayumu Makida, Tokyo (JP); Taeko Toshi, Tokyo (JP)

(73) Assignee: NIKON CORPORATION, (omitted)

(21) Appl. No.: 18/891,060

(22) Filed: Sep. 20, 2024

Related U.S. Application Data
(63) Continuation of application No. PCT/JP2023/011961, filed on Mar. 24, 2023.

(30) Foreign Application Priority Data
Mar. 29, 2022 (JP) 2022-053866

(51) Int. Cl. G02B 9/64

(52) U.S. Cl. CPC G02B 9/64

(57) ABSTRACT

An optical system comprising, in order from an object side, a first lens group, an aperture stop, and a rear group that includes a first cemented lens comprising a positive lens and a negative lens is configured so as to satisfy the following conditional expressions:

0.350<Bf/y<0.700

1.350<TL/y<2.000

0.050<Np1−Nn1<0.400

where Bf is a back focal length in air; y is maximum image height; TL is the distance from a lens surface closest to the object side to an image plane; and Np1 and Nn1 are the refractive indices of the positive and negative lenses constituting the first cemented lens, respectively.

### CROSS-REFERENCE TO RELATED APPLICATIONS

This application is a continuation of International Patent Application No. PCT/JP2023/011961 filed Mar. 24, 2023, which claims priority from Japanese Patent Application No. 2022-053866 filed Mar. 29, 2022, which are incorporated herein by reference.

### FIELD

The present disclosure relates to an optical system, an optical apparatus, and a method for manufacturing an optical system.

### BACKGROUND

Optical systems used in optical apparatuses, such as cameras for photographs, electronic still cameras, and video cameras, have been proposed (see, e.g., Japanese Unexamined Patent Publication No. 2017-054078).

### SUMMARY

An optical system of the present disclosure comprises a first lens group, an aperture stop, and a rear group in order from an object side; the rear group includes a first cemented lens comprising a positive lens and a negative lens; the optical system satisfies the following conditional expressions.

$$0.35 < Bf / y < 0 \text{.700}$$

$$1.35 < TL / y < 2.0 \; 00$$

$$0.05 < Np 1 - Nn 1 < 0.4$$

where
Bf: back focal length in air
y: maximum image height
TL: the distance from a lens surface closest to the object side to an image plane
Np1: the refractive index of the positive lens constituting the first cemented lens
Nn1: the refractive index of the negative lens constituting the first cemented lens

An optical system of the present disclosure comprises a first lens group, an aperture stop, and a rear group in order from an object side; the rear group includes a first cemented lens comprises a positive lens and a negative lens; the first lens group includes a positive lens disposed closest to the object side; the optical system satisfies the following conditional expressions.

$$1. < f / y < 1 \text{.600}$$

$$0.025 < t 1 / f < 0.080$$

where
f: the focal length of the optical system
y: maximum image height
t1: the central thickness of the lens closest to the object side

A method for manufacturing an optical system of the present disclosure is a method for manufacturing an optical system comprising a first lens group, an aperture stop, and a rear group in order from an object side; the rear group includes a first cemented lens comprising a positive lens and a negative lens; the method includes disposing lenses so as to satisfy the following conditional expressions.

$$0.35 < Bf / y < 0 \text{.700}$$

$$1.35 < TL / y < 2.0 \; 00$$

$$0.05 < Np 1 - Nn 1 < 0.4$$

where
Bf: back focal length in air
y: maximum image height
TL: the distance from a lens surface closest to the object side to an image plane
Np1: the refractive index of the positive lens constituting the first cemented lens
Nn1: the refractive index of the negative lens constituting the first cemented lens

### BRIEF DESCRIPTION OF DRAWINGS

FIG. 1 is a cross-sectional view of an optical system of a first example focusing on an object at infinity.

FIG. 2 shows aberrations of the optical system of the first example focusing on an object at infinity.

FIG. 3 is a cross-sectional view of an optical system of a second example focusing on an object at infinity.

FIG. 4 shows aberrations of the optical system of the second example focusing on an object at infinity.

FIG. 5 is a cross-sectional view of an optical system of a third example focusing on an object at infinity.

FIG. 6 shows aberrations of the optical system of the third example focusing on an object at infinity.

FIG. 7 is a cross-sectional view of an optical system of a fourth example focusing on an object at infinity.

FIG. 8 shows aberrations of the optical system of the fourth example focusing on an object at infinity.

FIG. 9 is a cross-sectional view of an optical system of a fifth example focusing on an object at infinity.

FIG. 10 shows aberrations of the optical system of the fifth example focusing on an object at infinity.

FIG. 11 schematically shows a camera including an optical system of the embodiment.

FIG. 12 is a flowchart outlining a method for manufacturing an optical system of the embodiment.

### DESCRIPTION OF EMBODIMENTS

The following describes an optical system, an optical apparatus, and a method for manufacturing an optical system of an embodiment of the present application.

An optical system of the present embodiment comprises a first lens group, an aperture stop, and a rear group in order from an object side; the rear group includes a first cemented lens comprising a positive lens and a negative lens; the optical system satisfies the following conditional expressions.

$$0.35 0 < Bf / y < 0.700 \qquad ( 1 )$$

$$1.35 < TL / y < 2 \text{.000} \qquad ( 2 )$$

$$0.05 < Np 1 - Nn 1 < 0.4 \qquad ( 3 )$$

where
Bf: back focal length in air
y: maximum image height
TL: the distance from a lens surface closest to the object side to an image plane
Np1: the refractive index of the positive lens constituting the first cemented lens
Nn1: the refractive index of the negative lens constituting the first cemented lens

The optical system of the present embodiment can correct chromatic aberration favorably, maintain the Petzval sum at an appropriate value, and correct curvature of field favorably, by the rear group including the first cemented lens.

Conditional expression (1) restricts the ratio of a back focal length in air to maximum image height. The optical system of the present embodiment, which satisfies conditional expression (1), can correct aberrations appropriately and have a back focal length appropriate for disposing a necessary filter or the like between the optical system and the image plane.

If the value of conditional expression (1) is greater than the upper limit in the optical system of the present embodiment, the back focal length will be too long, causing the optical system to have a long total length. If the length of the optical system except for the back focal length is reduced to shorten the total length, it will be difficult to correct aberrations appropriately.

In the optical system of the present embodiment, the effect of the present embodiment can be ensured by setting the upper limit of conditional expression (1) to 0.700. To further ensure the effect of the present embodiment, the upper limit of conditional expression (1) is preferably set to 0.691, more preferably to 0.550.

If the value of conditional expression (1) is less than the lower limit in the optical system of the present embodiment, the back focal length will be too short, making it difficult to dispose a filter or the like in front of an imaging device and causing low-quality image signals to be outputted from the imaging device.

In the optical system of the present embodiment, the effect of the present embodiment can be ensured by setting the lower limit of conditional expression (1) to 0.350. To further ensure the effect of the present embodiment, the lower limit of conditional expression (1) is preferably set to 0.369, more preferably to 0.400.

Conditional expression (2) restricts the ratio of the distance from a lens surface closest to the object side to an image plane (total optical length) to maximum image height. The optical system of the present embodiment, which satisfies conditional expression (2), can avoid having a long total length, reduce the occurrence of shading of the imaging device, and correct aberrations appropriately.

If the value of conditional expression (2) is greater than the upper limit in the optical system of the present embodiment, the optical system will be increased in total length and upsized.

In the optical system of the present embodiment, the effect of the present embodiment can be ensured by setting the upper limit of conditional expression (2) to 2.000. To further ensure the effect of the present embodiment, the upper limit of conditional expression (2) is preferably set to 1.843, more preferably to 1.820.

If the value of conditional expression (2) is less than the lower limit in the optical system of the present embodiment, light beams will enter the imaging device at a large angle, causing shading and making it difficult to correct aberrations.

In the optical system of the present embodiment, the effect of the present embodiment can be ensured by setting the lower limit of conditional expression (2) to 1.350. To further ensure the effect of the present embodiment, the lower limit of conditional expression (2) is preferably set to 1.400, more preferably to 1.600.

Conditional expression (3) restricts the difference between the refractive indices of the positive and negative lenses constituting the first cemented lens. The optical system of the present embodiment can reduce the occurrence of aberrations appropriately by including a first cemented lens satisfying conditional expression (3).

If the value of conditional expression (3) is greater than the upper limit in the optical system of the present embodiment, refractive power will be too strong on the bonding surface of the first cemented lens, causing large aberrations.

In the optical system of the present embodiment, the effect of the present embodiment can be ensured by setting the upper limit of conditional expression (3) to 0.400. To further ensure the effect of the present embodiment, the upper limit of conditional expression (3) is preferably set to 0.350, more preferably to 0.300.

If the value of conditional expression (3) is less than the lower limit in the optical system of the present embodiment, the first cemented lens will fail to correct the Petzval sum appropriately, which makes it difficult for the optical system to reduce curvature of field.

In the optical system of the present embodiment, the effect of the present embodiment can be ensured by setting the lower limit of conditional expression (3) to 0.050. To further ensure the effect of the present embodiment, the lower limit of conditional expression (3) is preferably set to 0.060, more preferably to 0.070.

An optical system satisfying conditional expressions (1), (2), and (3) can avoid having a long total length, have an appropriate back focal length, reduce the occurrence of shading of the imaging device, and correct aberrations appropriately.

An optical system of the present embodiment comprises a first lens group, an aperture stop, and a rear group in order from an object side; the rear group includes a first cemented lens comprising a positive lens and a negative lens; the optical system satisfies the following conditional expressions.

$$0.35 0 < Bf / y < 0.700 \qquad ( 1 )$$

$$1.35 < TL / y < 2 \text{.000} \qquad ( 2 )$$

$$1.5 0 < tp 1 / tn 1 < 7. \qquad ( 4 )$$

where
Bf: back focal length in air
y: maximum image height
TL: the distance from a lens surface closest to the object side to an image plane
tp1: the central thickness of the positive lens constituting the first cemented lens
tn1: the central thickness of the negative lens constituting the first cemented lens

Conditional expression (4) restricts the ratio between the central thicknesses of the positive and negative lenses constituting the first cemented lens. The optical system of the present embodiment, which satisfies conditional expression (4), can avoid having a long total length and correct aberrations appropriately.

If the value of conditional expression (4) is greater than the upper limit in the optical system of the present embodiment, the positive lens constituting the first cemented lens will be too thick on the optical axis, causing the optical system to have a long total length.

In the optical system of the present embodiment, the effect of the present embodiment can be ensured by setting the upper limit of conditional expression (4) to 7.000. To further ensure the effect of the present embodiment, the upper limit of conditional expression (4) is preferably set to 6.000, more preferably to 5.000.

If the value of conditional expression (4) is less than the lower limit in the optical system of the present embodiment, the refractive power of the positive lens constituting the first cemented lens will not be sufficiently strong, making it difficult to correct aberrations, such as chromatic aberration and Petzval sum.

In the optical system of the present embodiment, the effect of the present embodiment can be ensured by setting the lower limit of conditional expression (4) to 1.500. To further ensure the effect of the present embodiment, the lower limit of conditional expression (4) is preferably set to 1.800, more preferably to 3.000.

An optical system satisfying conditional expressions (1), (2), and (4) can avoid having a long total length, have an appropriate back focal length, reduce the occurrence of shading of the imaging device, and correct aberrations appropriately.

An optical system of the present embodiment comprises a first lens group, an aperture stop, and a rear group in order from an object side; the rear group includes a first cemented lens comprising a positive lens and a negative lens; the first lens group includes a positive lens disposed closest to the object side; the optical system satisfies the following conditional expressions.

$$1. 0 < f / y < 1.600 \qquad ( 5 )$$

$$0.025 < t 1 / f < 0.080 \qquad ( 6 )$$

where
f: the focal length of the optical system
y: maximum image height
t1: the central thickness of the lens closest to the object side

Conditional expression (5) restricts the ratio of the focal length of the optical system to maximum image height. The optical system of the present embodiment, which satisfies conditional expression (5), can avoid having a long total length and correct spherical aberration and coma aberration appropriately.

If the value of conditional expression (5) is greater than the upper limit in the optical system of the present embodiment, the focal length of the optical system will be too long, causing the optical system to have a long total length. If an attempt is made to shorten the total length of the optical system, it will be difficult to correct aberrations appropriately.

In the optical system of the present embodiment, the effect of the present embodiment can be ensured by setting the upper limit of conditional expression (5) to 1.600. To further ensure the effect of the present embodiment, the upper limit of conditional expression (5) is preferably set to 1.550, more preferably to 1.500.

If the value of conditional expression (5) is less than the lower limit in the optical system of the present embodiment, the difference between the angles of deviation of on-axis beams and off-axis beams with respect to the lens closest to the object side will be increased, making it difficult to correct spherical aberration caused by on-axis beams and coma aberration caused by off-axis beams simultaneously.

In the optical system of the present embodiment, the effect of the present embodiment can be ensured by setting the lower limit of conditional expression (5) to 1.000. To further ensure the effect of the present embodiment, the lower limit of conditional expression (5) is preferably set to 1.100, more preferably to 1.200.

Conditional expression (6) restricts the ratio of the central thickness of the lens closest to the object side to the focal length of the optical system. The optical system of the present embodiment, which satisfies conditional expression (6), can position an exit pupil appropriately and correct coma aberration appropriately.

If the value of conditional expression (6) is greater than the upper limit in the optical system of the present embodiment, the positive lens disposed closest to the object side will be too thick and the position of the aperture stop will be closer to the image plane, making it difficult to position an exit pupil appropriately.

In the optical system of the present embodiment, the effect of the present embodiment can be ensured by setting the upper limit of conditional expression (6) to 0.080. To further ensure the effect of the present embodiment, the upper limit of conditional expression (6) is preferably set to 0.075, more preferably to 0.070.

If the value of conditional expression (6) is less than the lower limit in the optical system of the present embodiment, the positive lens disposed closest to the object side will be too thin, making it difficult to correct coma aberration.

In the optical system of the present embodiment, the effect of the present embodiment can be ensured by setting the lower limit of conditional expression (6) to 0.025. To further ensure the effect of the present embodiment, the lower limit of conditional expression (6) is preferably set to 0.030, more preferably to 0.035.

An optical system satisfying conditional expressions (5) and (6) can avoid having a long total length, position an exit pupil appropriately, and correct spherical aberration and coma aberration appropriately.

The optical system of the present embodiment preferably satisfies the following conditional expression.

3.000<vdp1−vdn1<30.000 (7)

where
vdp1: the Abbe number based on d-line of the positive lens constituting the first cemented lens
vdn1: the Abbe number based on d-line of the negative lens constituting the first cemented lens

Conditional expression (7) restricts the difference between the Abbe numbers based on d-line of the positive and negative lenses constituting the first cemented lens. The optical system of the present embodiment, which satisfies conditional expression (7), can correct chromatic aberration appropriately with the first cemented lens.

If the value of conditional expression (7) is greater than the upper limit in the optical system of the present embodiment, correction of chromatic aberration by the first cemented lens will be too much.

In the optical system of the present embodiment, the effect of the present embodiment can be ensured by setting the upper limit of conditional expression (7) to 30.000. To further ensure the effect of the present embodiment, the upper limit of conditional expression (7) is preferably set to 25.000, more preferably to 20.000.

If the value of conditional expression (7) is less than the lower limit in the optical system of the present embodiment, correction of chromatic aberration by the first cemented lens will be too little.

In the optical system of the present embodiment, the effect of the present embodiment can be ensured by setting the lower limit of conditional expression (7) to 3.000. To further ensure the effect of the present embodiment, the lower limit of conditional expression (7) is preferably set to 4.500, more preferably to 5.000.

In the optical system of the present embodiment, the rear group preferably includes a second cemented lens that comprises a positive lens and a negative lens, and that differs from the first cemented lens.

The optical system of the present embodiment with such a configuration can correct lateral chromatic aberration appropriately.

The optical system of the present embodiment preferably satisfies the following conditional expression.

1.000<f/y<1.380 (8)
f: the focal length of the optical system

Conditional expression (8) restricts the ratio of the focal length of the optical system to maximum image height. The optical system of the present embodiment, which satisfies conditional expression (8), can correct lateral chromatic aberration appropriately with the first and second cemented lenses and correct spherical aberration and coma aberration appropriately.

If the value of conditional expression (8) is greater than the upper limit in the optical system of the present embodiment, lateral chromatic aberration will not be corrected appropriately with the first and second cemented lenses.

In the optical system of the present embodiment, the effect of the present embodiment can be ensured by setting the upper limit of conditional expression (8) to 1.380. To further ensure the effect of the present embodiment, the upper limit of conditional expression (8) is preferably set to 1.330, more preferably to 1.280.

If the value of conditional expression (8) is less than the lower limit in the optical system of the present embodiment, the difference between the angles of deviation of on-axis beams and off-axis beams with respect to the lens closest to the object side will be increased, making it difficult to correct spherical aberration and coma aberration appropriately.

In the optical system of the present embodiment, the effect of the present embodiment can be ensured by setting the lower limit of conditional expression (8) to 1.000. To further ensure the effect of the present embodiment, the lower limit of conditional expression (8) is preferably set to 1.100, more preferably to 1.200.

In the optical system of the present embodiment, among the first and second cemented lenses, one cemented lens disposed on the object side preferably has the negative lens on the object side, and the other cemented lens disposed on the image plane side preferably has the negative lens on the image plane side.

The optical system of the present embodiment can correct aberrations, in particular, spherical aberration effectively by the negative lens of the cemented lens being disposed on the object side where on-axis beams are thicker. Further, the optical system can correct aberrations, in particular, coma aberration effectively by the first and second cemented lenses being symmetrical.

The optical system of the present embodiment preferably satisfies the following conditional expression.

$$- 0.030 < fc 1 / fc 2 < 1. \qquad ( 9 )$$

where
fc1: the combined focal length of one of the first and second cemented lenses disposed on the object side
fc2: the combined focal length of the other of the first and second cemented lenses disposed on the image plane side

Conditional expression (9) restricts the ratio of the combined focal length of one of the first and second cemented lenses disposed on the object side to that of the other of the first and second cemented lenses disposed on the image plane side. The optical system of the present embodiment, which satisfies conditional expression (9), can avoid having a long total length and reduce the occurrence of spherical aberration.

If the value of conditional expression (9) is greater than the upper limit in the optical system of the present embodiment, the other of the first and second cemented lenses disposed on the image plane side will have too strong refractive power, causing the total length of the optical system to be too long.

In the optical system of the present embodiment, the effect of the present embodiment can be ensured by setting the upper limit of conditional expression (9) to 1.000. To further ensure the effect of the present embodiment, the upper limit of conditional expression (9) is preferably set to 0.960, more preferably to 0.930.

If the value of conditional expression (9) is less than the lower limit in the optical system of the present embodiment, the one of the first and second cemented lenses disposed on the object side will have too strong refractive power, causing spherical aberration.

In the optical system of the present embodiment, the effect of the present embodiment can be ensured by setting the lower limit of conditional expression (9) to −0.030. To further ensure the effect of the present embodiment, the lower limit of conditional expression (9) is preferably set to −0.020, more preferably to −0.010.

The optical system of the present embodiment preferably satisfies the following conditional expression.

$$0.0 \; 50 < Np 2 - Nn 2 < 0.400 \qquad ( 10 )$$

where
Np2: the refractive index of the positive lens constituting the second cemented lens
Nn2: the refractive index of the negative lens constituting the second cemented lens

Conditional expression (10) restricts the difference between the refractive indices of the positive and negative lenses constituting the second cemented lens. The optical system of the present embodiment can correct the Petzval sum appropriately by including a second cemented lens satisfying conditional expression (10).

If the value of conditional expression (10) is greater than the upper limit in the optical system of the present embodiment, refractive power will be too strong on the bonding surface of the second cemented lens, causing large aberration.

In the optical system of the present embodiment, the effect of the present embodiment can be ensured by setting the upper limit of conditional expression (10) to 0.400. To further ensure the effect of the present embodiment, the upper limit of conditional expression (10) is preferably set to 0.350, more preferably to 0.300.

If the value of conditional expression (10) is less than the lower limit in the optical system of the present embodiment, the second cemented lens will fail to correct the Petzval sum appropriately, causing curvature of field.

In the optical system of the present embodiment, the effect of the present embodiment can be ensured by setting the lower limit of conditional expression (10) to 0.050. To further ensure the effect of the present embodiment, the lower limit of conditional expression (10) is preferably set to 0.060, more preferably to 0.070.

The optical system of the present embodiment preferably satisfies the following conditional expression.

$$3.000 < vdp 2 - vdn 2 < 30.000 \qquad ( 11 )$$

where
vdp2: the Abbe number based on d-line of the positive lens constituting the second cemented lens
vdn2: the Abbe number based on d-line of the negative lens constituting the second cemented lens

Conditional expression (11) restricts the difference between the Abbe numbers based on d-line of the positive and negative lenses constituting the second cemented lens. The optical system of the present embodiment, which satisfies conditional expression (11), can correct chromatic aberration appropriately with the second cemented lens.

If the value of conditional expression (11) is greater than the upper limit in the optical system of the present embodiment, correction of chromatic aberration by the second cemented lens will be too much.

In the optical system of the present embodiment, the effect of the present embodiment can be ensured by setting the upper limit of conditional expression (11) to 30.000. To further ensure the effect of the present embodiment, the upper limit of conditional expression (11) is preferably set to 25.000, more preferably to 20.000.

If the value of conditional expression (11) is less than the lower limit in the optical system of the present embodiment, correction of chromatic aberration by the second cemented lens will be too little.

In the optical system of the present embodiment, the effect of the present embodiment can be ensured by setting the lower limit of conditional expression (11) to 3.000. To further ensure the effect of the present embodiment, the lower limit of conditional expression (11) is preferably set to 4.500, more preferably to 5.000.

The optical system of the present embodiment preferably satisfies the following conditional expression.

$$0.550 < ( \sum Δ Pzi ) / Δ Pz < 1.400 \qquad ( 12 )$$

where
ΣΔPzi: the total calculated by summing, for each of at least one cemented lens comprising a positive lens and a negative lens and included in the rear group, the Petzval sum of the cemented lens and the inverse of the combined focal length of the cemented lens
ΔPz: the sum of the Petzval sum of the optical system and the inverse of the focal length of the optical system

Conditional expression (12) restricts the ratio of the total calculated by summing, for each of at least one cemented lens comprising a positive lens and a negative lens and included in the rear group, the Petzval sum of the cemented lens and the inverse of the combined focal length of the cemented lens to the sum of the Petzval sum of the optical system and the inverse of the focal length of the optical system. In conditional expression (12), the numerator represents the capability of the cemented lens correcting the Petzval sum, and the denominator represents the capability of the optical system correcting the Petzval sum. The optical system of the present embodiment, which satisfies conditional expression (12), can correct the curvature of field appropriately with the cemented lens.

If the value of conditional expression (12) is greater than the upper limit in the optical system of the present embodiment, correction of curvature of field by the cemented lens will be too much.

In the optical system of the present embodiment, the effect of the present embodiment can be ensured by setting the upper limit of conditional expression (12) to 1.400. To further ensure the effect of the present embodiment, the upper limit of conditional expression (12) is preferably set to 1.200, more preferably to 1.100.

If the value of conditional expression (12) is less than the lower limit in the optical system of the present embodiment, correction of curvature of field by the cemented lens will be too little.

In the optical system of the present embodiment, the effect of the present embodiment can be ensured by setting the lower limit of conditional expression (12) to 0.550. To further ensure the effect of the present embodiment, the lower limit of conditional expression (12) is preferably set to 0.800, more preferably to 0.950.

The optical system of the present embodiment preferably satisfies the following conditional expression.

$$0.5 \; 25 < \sum D / TL < 0.967 \qquad ( 13 )$$

where
ΣD: the distance from the lens surface closest to the object side to a lens surface closest to the image plane side
TL: the distance from the lens surface closest to the object side to the image plane

Conditional expression (13) restricts the ratio of the distance from the lens surface closest to the object side to a lens surface closest to the image plane side to the distance from the lens surface closest to the object side to the image plane. The optical system of the present embodiment, which satisfies conditional expression (13), enables a lens necessary for correcting aberrations to be disposed and can have an appropriate back focal length.

If the value of conditional expression (13) is greater than the upper limit in the optical system of the present embodiment, the back focal length will be too short, making it difficult to dispose a filter or the like in front of the imaging device.

In the optical system of the present embodiment, the effect of the present embodiment can be ensured by setting the upper limit of conditional expression (13) to 0.967. To further ensure the effect of the present embodiment, the upper limit of conditional expression (13) is preferably set to 0.850, more preferably to 0.775.

If the value of conditional expression (13) is less than the lower limit in the optical system of the present embodiment, it will be difficult to dispose a lens necessary for correcting aberrations.

In the optical system of the present embodiment, the effect of the present embodiment can be ensured by setting the lower limit of conditional expression (13) to 0.525. To further ensure the effect of the present embodiment, the lower limit of conditional expression (13) is preferably set to 0.600, more preferably to 0.675.

The optical system of the present embodiment preferably satisfies the following conditional expression.

$$0.050 < dL1\_St / TL < 0.167 \qquad ( 14 )$$

where
dL1_St: the distance from the lens surface closest to the object side to the aperture stop
TL: the distance from the lens surface closest to the object side to the image plane

Conditional expression (14) restricts the ratio of the distance from the lens surface closest to the object side to the aperture stop to the distance from the lens surface closest to the object side to the image plane. The optical system of the present embodiment, which satisfies conditional expression (14), can reduce the occurrence of shading of the imaging device and correct spherical aberration appropriately.

If the value of conditional expression (14) is greater than the upper limit in the optical system of the present embodiment, the position of an exit pupil will be close to the image plane, causing shading of the imaging device.

In the optical system of the present embodiment, the effect of the present embodiment can be ensured by setting the upper limit of conditional expression (14) to 0.167. To further ensure the effect of the present embodiment, the upper limit of conditional expression (14) is preferably set to 0.145, more preferably to 0.130.

If the value of conditional expression (14) is less than the lower limit in the optical system of the present embodiment, the optical system upstream of the aperture stop will fail to correct aberration sufficiently, making it difficult to correct spherical aberration.

In the optical system of the present embodiment, the effect of the present embodiment can be ensured by setting the lower limit of conditional expression (14) to 0.050. To further ensure the effect of the present embodiment, the lower limit of conditional expression (14) is preferably set to 0.055, more preferably to 0.070.

The optical system of the present embodiment preferably satisfies the following conditional expression.

$$0.75 < TL / f < 1.6 \qquad ( 15 )$$

where
TL: the distance from the lens surface closest to the object side to the image plane
f: the focal length of the optical system

Conditional expression (15) restricts the ratio of the distance from the lens surface closest to the object side to the image plane to the focal length of the optical system. The optical system of the present embodiment, which satisfies conditional expression (15), can avoid having a long total length, reduce the occurrence of shading of the imaging device, and correct aberrations appropriately.

If the value of conditional expression (15) is greater than the upper limit in the optical system of the present embodiment, the total length of the optical system will be too long. Further, the focal length will be too short with respect to the total length, and the focal lengths of the respective groups will be short, making it difficult to correct coma aberration and spherical aberration.

In the optical system of the present embodiment, the effect of the present embodiment can be ensured by setting the upper limit of conditional expression (15) to 1.600. To further ensure the effect of the present embodiment, the upper limit of conditional expression (15) is preferably set to 1.500, more preferably to 1.450.

If the value of conditional expression (15) is less than the lower limit in the optical system of the present embodiment, the total length of the optical system will be too short, making it difficult to appropriately dispose a lens for correcting aberrations. Further, the position of an exit pupil will be close to the image plane, causing shading of the imaging device.

In the optical system of the present embodiment, the effect of the present embodiment can be ensured by setting the lower limit of conditional expression (15) to 0.750. To further ensure the effect of the present embodiment, the lower limit of conditional expression (15) is preferably set to 0.900, more preferably to 1.100.

The optical system of the present embodiment preferably satisfies the following conditional expression.

$$0.59 < TLs / TL < 1.33 \qquad ( 16 )$$

where
TLs: the distance from the aperture stop plane to the image plane
TL: the distance from the lens surface closest to the object side to the image plane

Conditional expression (16) restricts the ratio of the distance from the aperture stop plane to the image plane to the distance from the lens surface closest to the object side to the image plane. The optical system of the present embodiment, which satisfies conditional expression (16), can correct spherical aberration appropriately and reduce the occurrence of shading of the imaging device.

In the optical system of the present embodiment, the effect of the present embodiment can be ensured by setting the upper limit of conditional expression (16) to 1.333. To further ensure the effect of the present embodiment, the upper limit of conditional expression (16) is preferably set to 1.150, more preferably to 0.950.

If the value of conditional expression (16) is less than the lower limit in the optical system of the present embodiment, the position of an exit pupil will be close to the image plane, causing shading of the imaging device.

In the optical system of the present embodiment, the effect of the present embodiment can be ensured by setting the lower limit of conditional expression (16) to 0.590. To further ensure the effect of the present embodiment, the lower limit of conditional expression (16) is preferably set to 0.625, more preferably to 0.750.

The optical system of the present embodiment preferably satisfies the following conditional expression.

$$0.7 < f 1 / f < 5. \qquad ( 17 )$$

where
f1: the focal length of the first lens group
f: the focal length of the optical system

Conditional expression (17) restricts the ratio between the focal lengths of the first lens group and the optical system. The optical system of the present embodiment, which satisfies conditional expression (17), can avoid having a long total length and reduce the occurrence of aberrations, such as spherical aberration and coma aberration.

If the value of conditional expression (17) is greater than the upper limit in the optical system of the present embodiment, the first lens group will have weak positive refractive power, causing the total length of the optical system to be too long.

In the optical system of the present embodiment, the effect of the present embodiment can be ensured by setting the upper limit of conditional expression (17) to 5.000. To further ensure the effect of the present embodiment, the upper limit of conditional expression (17) is preferably set to 4.800, more preferably to 4.650.

If the value of conditional expression (17) is less than the lower limit in the optical system of the present embodiment, the first lens group will have too strong positive refractive power, which is likely to cause aberrations, such as spherical aberration and coma aberration.

In the optical system of the present embodiment, the effect of the present embodiment can be ensured by setting the lower limit of conditional expression (17) to 0.700. To further ensure the effect of the present embodiment, the lower limit of conditional expression (17) is preferably set to 1.000, more preferably to 1.400.

In the optical system of the present embodiment, the first lens group preferably includes one or two lenses.

When the first lens group includes three or more lenses, the total length of the optical system of the present embodiment will be increased. Further, the position of the aperture stop plane will be closer to the image plane, and thus the exit pupil will be short, which is likely to cause shading of the imaging device.

The optical system of the present embodiment preferably satisfies the following conditional expression.

$$0.01 < D 1 / TL < 0.15 \qquad ( 18 )$$

where
D1: the distance from the lens surface closest to the object side in the first lens group to a lens surface closest to the image plane side in the first lens group
TL: the distance from the lens surface closest to the object side to the image plane

Conditional expression (18) restricts the ratio of the distance from the lens surface closest to the object side in the first lens group to a lens surface closest to the image plane side in the first lens group to the distance from the lens surface closest to the object side to the image plane. The optical system of the present embodiment, which satisfies conditional expression (18), can avoid having a long total length and correct coma aberration appropriately.

If the value of conditional expression (18) is greater than the upper limit in the optical system of the present embodiment, the first lens group will be thicker, causing the total length of the optical system to be too long.

In the optical system of the present embodiment, the effect of the present embodiment can be ensured by setting the upper limit of conditional expression (18) to 0.150. To further ensure the effect of the present embodiment, the upper limit of conditional expression (18) is preferably set to 0.130, more preferably to 0.110.

If the value of conditional expression (18) is less than the lower limit in the optical system of the present embodiment, the first lens group will be thinner, making it difficult to correct coma aberration.

In the optical system of the present embodiment, the effect of the present embodiment can be ensured by setting the lower limit of conditional expression (18) to 0.010. To further ensure the effect of the present embodiment, the lower limit of conditional expression (18) is preferably set to 0.020, more preferably to 0.025.

The optical system of the present embodiment is preferably composed of six to nine lenses.

When the optical system of the present embodiment is composed of ten or more lenses, the total thickness of the lenses will be increased, causing the optical system to have a long total length. When the optical system of the present embodiment is composed of five or fewer lenses, it will be difficult to correct aberrations appropriately.

The optical system of the present embodiment preferably satisfies the following conditional expression.

$$0.025 < t 1 / Σ D < 0.08 \qquad ( 19 )$$

where
t1: the central thickness of the lens closest to the object side
ΣD: the distance from the lens surface closest to the object side to a lens surface closest to the image plane side

Conditional expression (19) restricts the ratio of the central thickness of the lens closest to the object side to the distance from the lens surface closest to the object side to a lens surface closest to the image plane side. The optical system of the present embodiment, which satisfies conditional expression (19), can reduce the occurrence of shading of the imaging device and correct coma aberration appropriately.

If the value of conditional expression (19) is greater than the upper limit in the optical system of the present embodiment, the central thickness of the lens closest to the object side will be large to cause the position of the aperture stop plane to be closer to the image plane, and thus the exit pupil will be short, which is likely to cause shading of the imaging device.

In the optical system of the present embodiment, the effect of the present embodiment can be ensured by setting the upper limit of conditional expression (19) to 0.080. To further ensure the effect of the present embodiment, the upper limit of conditional expression (19) is preferably set to 0.070.

If the value of conditional expression (19) is less than the lower limit in the optical system of the present embodiment, the central thickness of the lens closest to the object side will be small, making it difficult to correct coma aberration.

In the optical system of the present embodiment, the effect of the present embodiment can be ensured by setting the lower limit of conditional expression (19) to 0.025. To further ensure the effect of the present embodiment, the lower limit of conditional expression (19) is preferably set to 0.030, more preferably to 0.035.

The optical system of the present embodiment preferably satisfies the following conditional expression.

$$- 4.5 < ( rR 2 + rR 1 ) / ( rR 2 - rR 1 ) < - 1.5 \qquad ( 20 )$$

where
rR1: the radius of curvature of an object-side lens surface of a lens closest to the image plane side
rR2: the radius of curvature of an image-plane-side lens surface of a lens closest to the image plane side

Conditional expression (20) restricts the shape factor of a lens closest to the image plane side. The optical system of the present embodiment, which satisfies conditional expression (20), can reduce the occurrence of curvature of field appropriately.

If the value of conditional expression (20) is greater than the upper limit in the optical system of the present embodiment, the angle of incidence on the object-side lens surface of the lens closest to the image plane side will be increased, which is likely to cause curvature of field.

In the optical system of the present embodiment, the effect of the present embodiment can be ensured by setting the upper limit of conditional expression (20) to −1.500. To further ensure the effect of the present embodiment, the upper limit of conditional expression (20) is preferably set to −1.800, more preferably to −2.000.

If the value of conditional expression (20) is less than the lower limit in the optical system of the present embodiment, the angle of incidence on the image-plane-side lens surface of the lens closest to the image plane side will be increased, which is likely to cause curvature of field.

In the optical system of the present embodiment, the effect of the present embodiment can be ensured by setting the lower limit of conditional expression (20) to −4.500. To further ensure the effect of the present embodiment, the lower limit of conditional expression (20) is preferably set to −4.000, more preferably to −3.000.

The optical system of the present embodiment preferably satisfies the following conditional expression.

$$0.13 < tR / Σ D < 0.35 \qquad ( 21 )$$

where
tR: the central thickness of a lens closest to the image plane side
ΣD: the distance from the lens surface closest to the object side to a lens surface closest to the image plane side

Conditional expression (21) restricts the ratio of the central thickness of a lens closest to the image plane side to the distance from the lens surface closest to the object side to a lens surface closest to the image plane side. The optical system of the present embodiment, which satisfies conditional expression (21), can avoid having a long total length and reduce the occurrence of shading of the imaging device.

If the value of conditional expression (21) is greater than the upper limit in the optical system of the present embodiment, the total length of the optical system will be too long.

In the optical system of the present embodiment, the effect of the present embodiment can be ensured by setting the upper limit of conditional expression (21) to 0.350. To further ensure the effect of the present embodiment, the upper limit of conditional expression (21) is preferably set to 0.300, more preferably to 0.270.

If the value of conditional expression (21) is less than the lower limit in the optical system of the present embodiment, the central thickness of a lens closest to the image plane side will be small to weaken positive refractive power, and thus the position of an exit pupil will be close to the image plane, which is likely to cause shading of the imaging device.

In the optical system of the present embodiment, the effect of the present embodiment can be ensured by setting the lower limit of conditional expression (21) to 0.130. To further ensure the effect of the present embodiment, the lower limit of conditional expression (21) is preferably set to 0.150, more preferably to 0.180.

In the optical system of the present embodiment, preferably, the rear group includes, in order from the object side, a second lens group, a third lens group having negative refractive power, and a fourth lens group; on the object side the third lens group includes a negative meniscus lens disposed closest to the image plane side of negative meniscus lenses concave on the object side that are disposed closer to the image plane than the aperture stop; and the fourth lens group comprises a positive lens.

The optical system of the present embodiment with such a configuration can increase the distance between the exit pupil and the image plane and correct curvature of field favorably.

The optical system of the present embodiment preferably satisfies the following conditional expression.

$$0.3 < ( - f 3 ) / f < 2.2 \qquad ( 22 )$$

where
f3: the focal length of the third lens group
f: the focal length of the optical system

Conditional expression (22) restricts the ratio between the focal lengths of the third lens group and the optical system. The optical system of the present embodiment, which satisfies conditional expression (22), can avoid having a long total length and correct aberrations, such as coma aberration in the sagittal direction and curvature of field, appropriately.

If the value of conditional expression (22) is greater than the upper limit in the optical system of the present embodiment, the total length of the optical system will be too long. Further, it will be difficult to set an exit pupil at an appropriate position.

In the optical system of the present embodiment, the effect of the present embodiment can be ensured by setting the upper limit of conditional expression (22) to 2.200. To further ensure the effect of the present embodiment, the upper limit of conditional expression (22) is preferably set to 1.600, more preferably to 1.300.

If the value of conditional expression (22) is less than the lower limit in the optical system of the present embodiment, the third lens group will have too strong refractive power, making it difficult to correct aberrations, such as coma aberration in the sagittal direction and curvature of field.

In the optical system of the present embodiment, the effect of the present embodiment can be ensured by setting the lower limit of conditional expression (22) to 0.300. To further ensure the effect of the present embodiment, the lower limit of conditional expression (22) is preferably set to 0.450, more preferably to 0.750.

The optical system of the present embodiment preferably satisfies the following conditional expression.

$$0.45 < f 4 / f < 2.3 \qquad ( 23 )$$

where
f4: the focal length of the fourth lens group
f: the focal length of the optical system

Conditional expression (23) restricts the ratio between the focal lengths of the fourth lens group and the optical system. The optical system of the present embodiment, which satisfies conditional expression (23), can reduce the occurrence of shading of the imaging device and avoid having a long total length.

If the value of conditional expression (23) is greater than the upper limit in the optical system of the present embodiment, the position of an exit pupil will be close to the image plane, which is likely to cause shading of the imaging device. Further, it will also be difficult to correct the Petzval sum.

In the optical system of the present embodiment, the effect of the present embodiment can be ensured by setting the upper limit of conditional expression (23) to 2.300. To further ensure the effect of the present embodiment, the upper limit of conditional expression (23) is preferably set to 1.680, more preferably to 1.500.

If the value of conditional expression (23) is less than the lower limit in the optical system of the present embodiment, the total length of the optical system will be too long.

In the optical system of the present embodiment, the effect of the present embodiment can be ensured by setting the lower limit of conditional expression (23) to 0.450. To further ensure the effect of the present embodiment, the lower limit of conditional expression (23) is preferably set to 0.650, more preferably to 1.000.

The optical system of the present embodiment preferably satisfies the following conditional expression.

$$0.286 < ( - f 3 ) / f 4 < 2. \qquad ( 24 )$$

where
f3: the focal length of the third lens group
f4: the focal length of the fourth lens group

Conditional expression (24) restricts the ratio between the focal lengths of the third and fourth lens groups. The optical system of the present embodiment, which satisfies conditional expression (24), can correct aberrations, such as curvature of field and coma aberration, appropriately with the third and fourth lens groups.

If the value of conditional expression (24) is greater than the upper limit in the optical system of the present embodiment, the third lens group will have too strong refractive power, making it difficult to correct aberrations, such as curvature of field and coma aberration.

In the optical system of the present embodiment, the effect of the present embodiment can be ensured by setting the upper limit of conditional expression (24) to 2.000. To further ensure the effect of the present embodiment, the upper limit of conditional expression (24) is preferably set to 1.500, more preferably to 1.350.

If the value of conditional expression (24) is less than the lower limit in the optical system of the present embodiment, the fourth lens group will have too strong refractive power, making it difficult to correct aberrations, such as curvature of field and coma aberration.

In the optical system of the present embodiment, the effect of the present embodiment can be ensured by setting the lower limit of conditional expression (24) to 0.286. To further ensure the effect of the present embodiment, the lower limit of conditional expression (24) is preferably set to 0.350, more preferably to 0.600.

The optical system of the present embodiment preferably satisfies the following conditional expression.

$$0.3 < f 2 / f < 2. \qquad ( 25 )$$

where
f2: the focal length of the second lens group
f: the focal length of the optical system

Conditional expression (25) restricts the ratio between the focal lengths of the second lens group and the optical system. The optical system of the present embodiment, which satisfies conditional expression (25), can correct curvature of field favorably and correct coma aberration favorably so as not to vary between colors.

If the value of conditional expression (25) is greater than the upper limit in the optical system of the present embodiment, the Petzval sum will not be maintained at an appropriate value, making it difficult to correct curvature of field favorably.

In the optical system of the present embodiment, the effect of the present embodiment can be ensured by setting the upper limit of conditional expression (25) to 2.000. To further ensure the effect of the present embodiment, the upper limit of conditional expression (25) is preferably set to 1.800, more preferably to 1.500.

If the value of conditional expression (25) is less than the lower limit in the optical system of the present embodiment, it will be difficult to reduce variations in coma aberration between colors.

In the optical system of the present embodiment, the effect of the present embodiment can be ensured by setting the lower limit of conditional expression (25) to 0.300. To further ensure the effect of the present embodiment, the lower limit of conditional expression (25) is preferably set to 0.500, more preferably to 0.700.

The optical system of the present embodiment preferably satisfies the following conditional expression.

$$1.5 < ( r 312 + r 311 ) / ( r 312 - r 311 ) < 7. \qquad ( 26 )$$

where
r311: the radius of curvature of an object-side lens surface of the lens closest to the object side in the third lens group
r312: the radius of curvature of an image-plane-side lens surface of the lens closest to the object side in the third lens group

Conditional expression (26) restricts the shape factor of the lens closest to the object side in the third lens group. The optical system of the present embodiment, which satisfies conditional expression (26), can reduce the occurrence of curvature of field appropriately.

If the value of conditional expression (26) is greater than the upper limit or less than the lower limit in the optical system of the present embodiment, the angle of deviation of off-axis beams will be too large, which is likely to cause curvature of field.

In the optical system of the present embodiment, the effect of the present embodiment can be ensured by setting the upper limit of conditional expression (26) to 7.000. To further ensure the effect of the present embodiment, the upper limit of conditional expression (26) is preferably set to 5.000, more preferably to 3.000.

In the optical system of the present embodiment, the effect of the present embodiment can be ensured by setting the lower limit of conditional expression (26) to 1.500. To further ensure the effect of the present embodiment, the lower limit of conditional expression (26) is preferably set to 1.700, more preferably to 2.000.

The optical system of the present embodiment preferably satisfies the following conditional expression.

$$0.1 < d 3 / f < 0.75 \qquad ( 27 )$$

where
d3: the distance from the aperture stop to the lens surface closest to the object side in the third lens group
f: the focal length of the optical system

Conditional expression (27) restricts the ratio of the distance from the aperture stop to the lens surface closest to the object side in the third lens group to the focal length of the optical system. The optical system of the present embodiment, which satisfies conditional expression (27), can avoid having a long total length and reduce the occurrence of shading of the imaging device.

If the value of conditional expression (27) is greater than the upper limit in the optical system of the present embodiment, the total length of the optical system will be too long.

In the optical system of the present embodiment, the effect of the present embodiment can be ensured by setting the upper limit of conditional expression (27) to 0.750. To further ensure the effect of the present embodiment, the upper limit of conditional expression (27) is preferably set to 0.700, more preferably to 0.650.

If the value of conditional expression (27) is less than the lower limit in the optical system of the present embodiment, the position of an exit pupil will be close to the image plane, which is likely to cause shading of the imaging device.

In the optical system of the present embodiment, the effect of the present embodiment can be ensured by setting the lower limit of conditional expression (27) to 0.150. To further ensure the effect of the present embodiment, the lower limit of conditional expression (27) is preferably set to 0.200, more preferably to 0.250.

The optical system of the present embodiment preferably satisfies the following conditional expression.

$$0.4 < dL 1 \_Gr3 / ΣD < 0.9 \qquad ( 28 )$$

where
dL1_Gr3: the distance from the lens surface closest to the object side to a lens surface closest to the object side in the third lens group
ΣD: the distance from the lens surface closest to the object side to a lens surface closest to the image plane side

Conditional expression (28) restricts the ratio of the distance from the lens surface closest to the object side to a lens surface closest to the object side in the third lens group to the distance from the lens surface closest to the object side to a lens surface closest to the image plane side. The optical system of the present embodiment, which satisfies conditional expression (28), can avoid having a long total length and reduce the occurrence of shading of the imaging device.

If the value of conditional expression (28) is greater than the upper limit in the optical system of the present embodiment, the total length of the optical system will be too long.

In the optical system of the present embodiment, the effect of the present embodiment can be ensured by setting the upper limit of conditional expression (28) to 0.900. To further ensure the effect of the present embodiment, the upper limit of conditional expression (28) is preferably set to 0.850, more preferably to 0.800.

If the value of conditional expression (28) is less than the lower limit in the optical system of the present embodiment, the position of an exit pupil will be close to the image plane, which is likely to cause shading of the imaging device.

In the optical system of the present embodiment, the effect of the present embodiment can be ensured by setting the lower limit of conditional expression (28) to 0.400. To further ensure the effect of the present embodiment, the lower limit of conditional expression (28) is preferably set to 0.450, more preferably to 0.500.

A small-sized optical system of favorable imaging performance can be achieved by the above configurations.

An optical apparatus of the present embodiment includes an optical system configured as described above. This enables achieving an optical apparatus of favorable optical performance.

A method for manufacturing an optical system of the present embodiment is a method for manufacturing an optical system comprising a first lens group, an aperture stop, and a rear group in order from an object side; the rear group includes a first cemented lens comprising a positive lens and a negative lens; the method includes disposing lenses so as to satisfy the following conditional expressions.

$$0.35 < Bf / y < 0.7 \qquad ( 1 )$$

$$1.35 < TL / y < 2. \qquad ( 2 )$$

$$0.5 < Np 1 - Nn 1 < 0.4 \qquad ( 3 )$$

where
Bf: back focal length in air
y: maximum image height
TL: the distance from a lens surface closest to the object side to an image plane
Np1: the refractive index of the positive lens constituting the first cemented lens
Nn1: the refractive index of the negative lens constituting the first cemented lens

A method for manufacturing an optical system of the present embodiment is a method for manufacturing an optical system comprising a first lens group, an aperture stop, and a rear group in order from an object side; the rear group includes a first cemented lens comprising a positive lens and a negative lens; the method includes disposing lenses so as to satisfy the following conditional expressions.

$$0.35 < Bf / y < 0.7 \qquad ( 1 )$$

$$1.35 < TL / y < 2. \qquad ( 2 )$$

$$1.5 < tp 1 / tn 1 < 7. \qquad ( 4 )$$

where
Bf: back focal length in air
y: maximum image height
TL: the distance from a lens surface closest to the object side to an image plane
tp1: the thickness on the optical axis of the positive lens constituting the first cemented lens
tn1: the thickness on the optical axis of the negative lens constituting the first cemented lens

A method for manufacturing an optical system of the present embodiment is a method for manufacturing an optical system comprising a first lens group, an aperture stop, and a rear group in order from an object side; the rear group includes a first cemented lens comprising a positive lens and a negative lens; the method includes disposing lenses so as to satisfy the following conditional expressions.

$$1. < f / y < 1.6 \qquad ( 5 )$$

$$0.025 < t 1 / f < 0.08 \qquad ( 6 )$$

where
f: the focal length of the optical system
y: maximum image height
t1: the central thickness of a positive lens disposed closest to the object side

An optical system of favorable optical performance can be manufactured by such methods for manufacturing an optical system.

### Numerical Examples

Examples of the present application will be described below with reference to the drawings.

### First Example

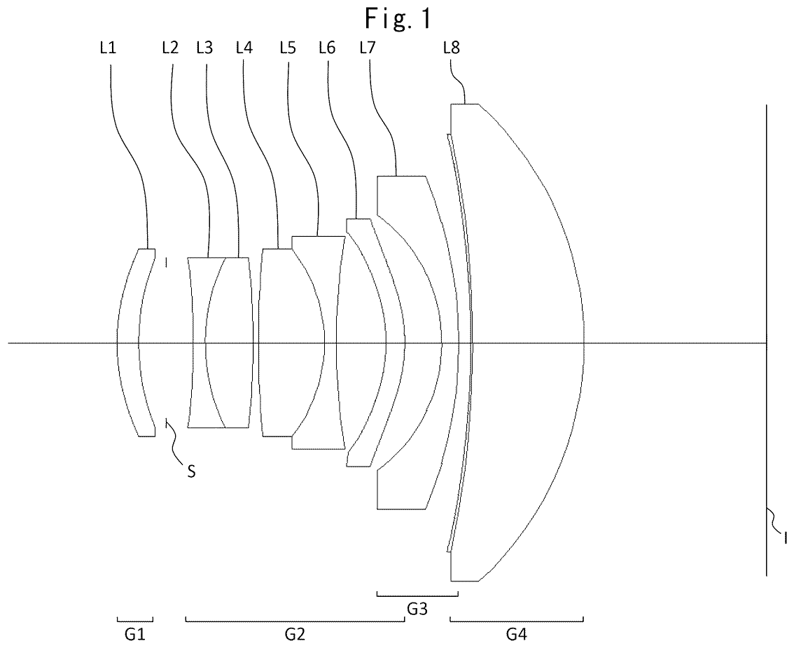

FIG. 1 is a cross-sectional view of an optical system of a first example focusing on an object at infinity.

The optical system of the present example includes, in order from the object side, a first lens group G1 having positive refractive power, an aperture stop S, a second lens group G2 having positive refractive power, a third lens group G3 having negative refractive power, and a fourth lens group G4 having positive refractive power.

The first lens group G1 consists of a meniscus-shaped positive lens L1 convex on the object side.

The second lens group G2 consists of, in order from the object side, a positive cemented lens consisting of a biconcave negative lens L2 and a biconvex positive lens L3, a positive cemented lens consisting of a biconvex positive lens L4 and a biconcave negative lens L5, and a meniscus-shaped positive lens L6 concave on the object side.

The third lens group G3 consists of a meniscus-shaped negative lens L7 concave on the object side.

The fourth lens group G4 consists of a meniscus-shaped positive lens L8 concave on the object side. The positive lens L8 is configured by providing a resin layer on the object-side surface of a glass lens body. The positive lens L8 is a compound-type aspherical lens in which the object-side surface of the resin layer is aspherical. In [Lens specifications] below, surface number 14 refers to the object-side surface of the resin layer, surface number 15 to the image-side surface of the resin layer and the object-side surface of the lens body (surfaces where the resin layer and the lens body are bonded together), and surface number 16 to the image-side surface of the lens body. In the present embodiment, a compound-type aspherical lens is treated as a single aspherical lens. Thus the surface having surface number 14 corresponds to the object-side lens surface of the positive lens L8, and the sum of the surface-to-surface distances of surface numbers 14 and 15 corresponds to the central thickness of the positive lens L8.

An imaging device (not shown) constructed from CCD, CMOS, or the like is disposed on an image plane I.

The optical system of the present example focuses by moving the whole optical system along the optical axis. When focus is shifted from infinity to a nearby object, the optical system of the present example moves from the image plane side toward the object side.

In the optical system of the present example, the second, third, and fourth lens groups correspond to the rear group. The positive cemented lens consisting of the negative lens L2 and the positive lens L3 corresponds to the first cemented lens, and the positive cemented lens consisting of the positive lens L4 and the negative lens L5 corresponds to the second cemented lens.

Table 1 below shows specifications of the optical system of the present example. In [Lens specifications] of Table 1, m denotes the numbers of optical surfaces counted from the object side, r the radii of curvature, d the surface-to-surface distances, n (d) the refractive indices at d-line (wavelength 587.6 nm), and vd the Abbe numbers based on d-line. The radius of curvature r=∞ means a plane. In [Lens specifications], the optical surfaces with “*” are aspherical surfaces.

In [Aspherical surface data], m denotes the optical surfaces corresponding to the aspherical surface data, K the conic constants, and A4 to A18 the aspherical coefficients.

The aspherical surfaces are expressed by expression (a) below, where y denotes the height in a direction perpendicular to the optical axis, S (y) the distance along the optical axis from the tangent plane at the vertex of an aspherical surface to the aspherical surface at height y (a sag), r the radius of curvature of a reference sphere (paraxial radius of curvature), K the conic constant, and An the nth-order aspherical coefficient. In the examples, the second-order aspherical coefficient A2 is 0. “E-n” means “x10”.”

$$S ( y ) = ( {y}^{2} / r ) / \{ 1 + {( 1 - K \times {y}^{2} / {r}^{2} )}^{1 / 2} \} + A 4 \times {y}^{4 +} A 6 \times {y}^{6 +} A 8 \times {y}^{8 +} A 10 \times {y}^{10} + A 12 \times {y}^{12 +} A 14 \times {y}^{14 +} A 16 \times {y}^{16 +} A 18 \times {y}^{18} \qquad ( a )$$

In [General specifications] of Table 1, f denotes the focal length of the optical system, F.NO the f-number of the optical system, w the semi-field angle (degrees), Y the maximum image height, and TL the distance from the lens surface closest to the object side to the image plane at focusing on an object at infinity.

In [Back focal length] of Table 1, Bf denotes the back focal length of the optical system in air.

The unit of the focal length f, the radii of curvature r, and the other lengths listed in Table 1 is “mm.” However, the unit is not limited thereto because the optical performance of a proportionally enlarged or reduced optical system is the same as that of the original optical system.

The above reference symbols in Table 1 will also be used similarly in the tables of the other examples described below.

TABLE 1
[Lens specifications]

| m | r | d | n(d) | νd |
|---|---|---|---|---|
| *1) | 11.70227 | 1.270 | 1.58913 | 61.1 |
| 2) | 13.38340 | 1.620 | | |
| 3> | ∞ | 1.590 | | (aperture stop) |
| 4) | −37.93400 | 0.700 | 1.59270 | 35.3 |
| 5) | 11.35394 | 2.800 | 1.88300 | 40.7 |
| 6) | −46.90284 | 0.310 | | |
| 7) | 58.38846 | 3.870 | 1.81600 | 46.6 |
| 8) | −8.93495 | 0.700 | 1.62004 | 36.4 |
| 9) | 39.69665 | 2.920 | | |
| *10) | −9.52831 | 1.100 | 1.58313 | 59.5 |
| *11) | −9.47003 | 2.170 | | |
| 12) | −9.36192 | 1.000 | 1.75520 | 27.6 |
| 13) | −25.39515 | 0.710 | | |
| *14) | −45.86660 | 0.100 | 1.56093 | 36.6 |
| 15) | −59.69914 | 6.530 | 1.88300 | 40.7 |
| 16) | −18.98009 | Bf | | |

[Aspherical surface data]

| m | 1) | 10) | 11) | 14) |
|---|---|---|---|---|
| K | 1.0000 | 0.2964 | 1.0000 | 1.0000 |
| A4 | −6.30E−05 | −1.07E−04 | 1.94E−04 | 4.28E−05 |
| A6 | −1.02E−06 | 1.09E−05 | 9.62E−06 | −3.34E−07 |
| A8 | −1.93E−08 | −1.04E−07 | 1.86E−08 | 1.25E−09 |
| A10 | −6.74E−09 | −3.79E−09 | −3.20E−12 | |
| A12 | 1.76E−10 | 3.78E−11 | 3.14E−15 | |
| A14 | 8.59E−14 | | | |
| A16 | −9.66E−14 | | | |
| A18 | 1.31E−15 | | | |

[General specifications]

| | |
|---|---|
| f | 26.78 |
| F. No | 2.90 |
| ω | 40.30 |
| Y | 21.05 |
| TL | 38.15 |

[Focal length data of groups]

| Groups | Starting surfaces | Focal lengths |
|---|---|---|
| G1 | 1 | 123.54 |
| G2 | 4 | 20.55 |
| G3 | 12 | −20.18 |
| G4 | 14 | 31.47 |

[Back focal length]

| | At focusing on infinity | At focusing on a nearby object |
|---|---|---|
| Bf | 10.760 | 15.873 |

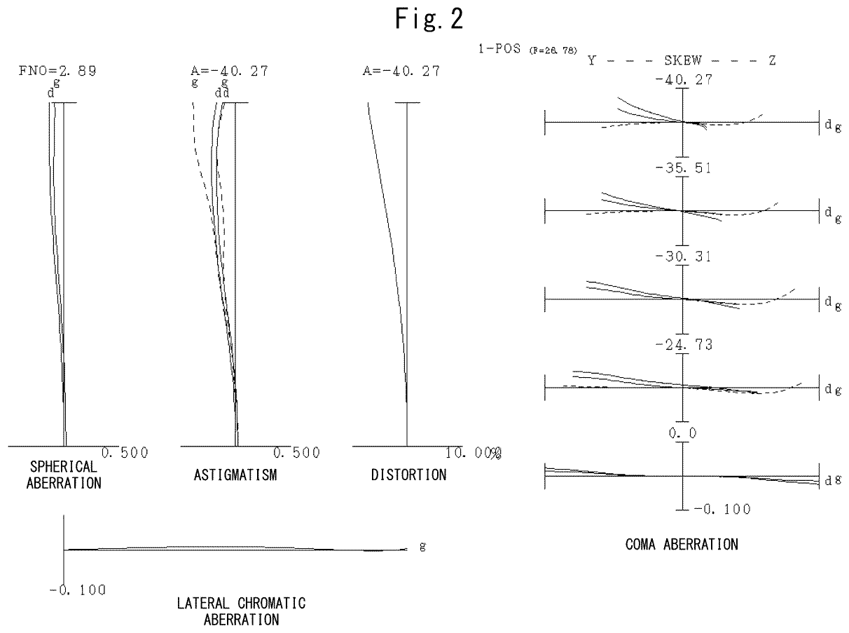

FIG. 2 shows aberrations of the optical system of the first example focusing on an object at infinity.

In the graphs of aberrations, FNO and Y denote f-number and image height, respectively. More specifically, the graph of spherical aberration shows the f-number corresponding to the maximum aperture, the graphs of astigmatism and distortion show the maximum of image height, and the graphs of coma aberration show the values of image height. d and g denote d-line and g-line (wavelength 435.8 nm), respectively. In the graph of astigmatism, the solid lines and the broken lines show a sagittal plane and a meridional plane, respectively. The reference symbols in the graphs of aberrations of the present example will also be used in those of the other examples described below.

The graphs of aberrations suggest that the optical system of the present example corrects aberrations appropriately and has high optical performance.

### Second Example

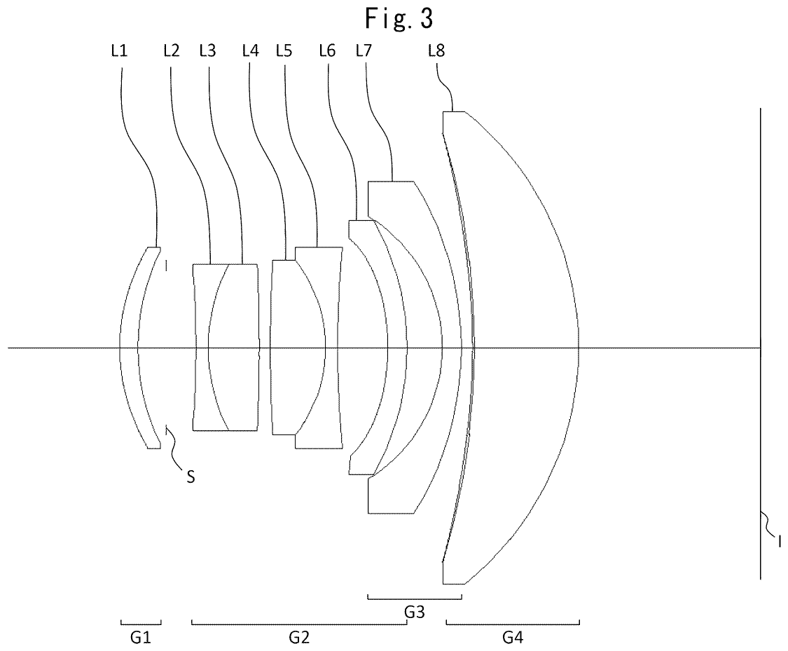

FIG. 3 is a cross-sectional view of an optical system of a second example focusing on an object at infinity.

The optical system of the present example includes, in order from the object side, a first lens group G1 having positive refractive power, an aperture stop S, a second lens group G2 having positive refractive power, a third lens group G3 having negative refractive power, and a fourth lens group G4 having positive refractive power.

The first lens group G1 consists of a meniscus-shaped positive lens L1 convex on the object side.

The second lens group G2 consists of, in order from the object side, a positive cemented lens composed of a biconcave negative lens L2 and a biconvex positive lens L3, a positive cemented lens composed of a biconvex positive lens L4 and a biconcave negative lens L5, and a meniscus-shaped negative lens L6 concave on the object side.

The third lens group G3 consists of a meniscus-shaped negative lens L7 concave on the object side.

The fourth lens group G4 consists of a meniscus-shaped positive lens L8 concave on the object side. The positive lens L8 is configured by providing a resin layer on the object-side surface of a glass lens body. The positive lens L8 is a compound-type aspherical lens in which the object-side surface of the resin layer is aspherical. In [Lens specifications] below, surface number 14 refers to the object-side surface of the resin layer, surface number 15 to the image-side surface of the resin layer and the object-side surface of the lens body (surfaces where the resin layer and the lens body are bonded together), and surface number 16 to the image-side surface of the lens body. The surface having surface number 14 corresponds to the object-side lens surface of the positive lens L8, and the sum of the surface-to-surface distances of surface numbers 14 and 15 corresponds to the central thickness of the positive lens L8.

An imaging device (not shown) constructed from CCD, CMOS, or the like is disposed on an image plane I.

The optical system of the present example focuses by moving the whole optical system along the optical axis. When focus is shifted from infinity to a nearby object, the optical system of the present example moves from the image plane side toward the object side.

In the optical system of the present example, the second, third, and fourth lens groups correspond to the rear group. The positive cemented lens composed of the negative lens L2 and the positive lens L3 corresponds to the first cemented lens, and the positive cemented lens composed of the positive lens L4 and the negative lens L5 corresponds to the second cemented lens.

Table 2 below shows specifications of the optical system of the present example.

TABLE 2
[Lens specifications]

| m | r | d | n(d) | νd |
|---|---|---|---|---|
| *1) | 10.67194 | 1.037 | 1.82098 | 42.5 |
| 2) | 12.50984 | 1.628 | | |
| 3> | ∞ | 1.687 | | (aperture stop) |
| 4) | −60.66908 | 0.700 | 1.59270 | 35.3 |
| 5) | 10.07412 | 2.912 | 1.88300 | 40.7 |
| 6) | −113.20557 | 0.639 | | |
| 7) | 88.89249 | 3.144 | 1.88300 | 40.7 |
| 8) | −8.19957 | 0.700 | 1.71736 | 29.6 |
| 9) | 59.76467 | 2.873 | | |
| *10) | −12.75253 | 1.100 | 1.82098 | 42.5 |
| 11) | −14.76677 | 2.007 | | |
| 12) | −8.77600 | 1.100 | 1.68376 | 37.6 |
| 13) | −17.99477 | 0.638 | | |
| *14) | −36.55640 | 0.100 | 1.56093 | 36.6 |
| 15) | −42.98427 | 5.955 | 1.84850 | 43.8 |
| 16) | −17.28034 | Bf | | |

[Aspherical surface data]

| m | 1) | 10) | 14) |
|---|---|---|---|
| K | 1.0000 | 0.2964 | 1.0000 |
| A4 | −4.34E−05 | −2.20E−04 | 3.68E−05 |
| A6 | 3.34E−08 | −4.66E−06 | −1.50E−07 |
| A8 | −2.62E−08 | 2.34E−07 | 1.39E−10 |
| A10 | −1.44E−08 | | |
| A12 | 3.40E−10 | | |
| A14 | −3.50E−12 | | |

[General specifications]

| | |
|---|---|
| f | 26.78 |
| F. No | 2.90 |
| ω | 40.30 |
| Y | 21.05 |
| TL | 36.67 |

[Focal length data of groups]

| Groups | Starting surfaces | Focal lengths |
|---|---|---|
| G1 | 1 | 70.54 |
| G2 | 4 | 26.69 |
| G3 | 12 | −26.33 |
| G4 | 14 | 32.68 |

[Back focal length]

| | At focusing on infinity | At focusing on a nearby object |
|---|---|---|
| Bf | 10.454 | 15.521 |

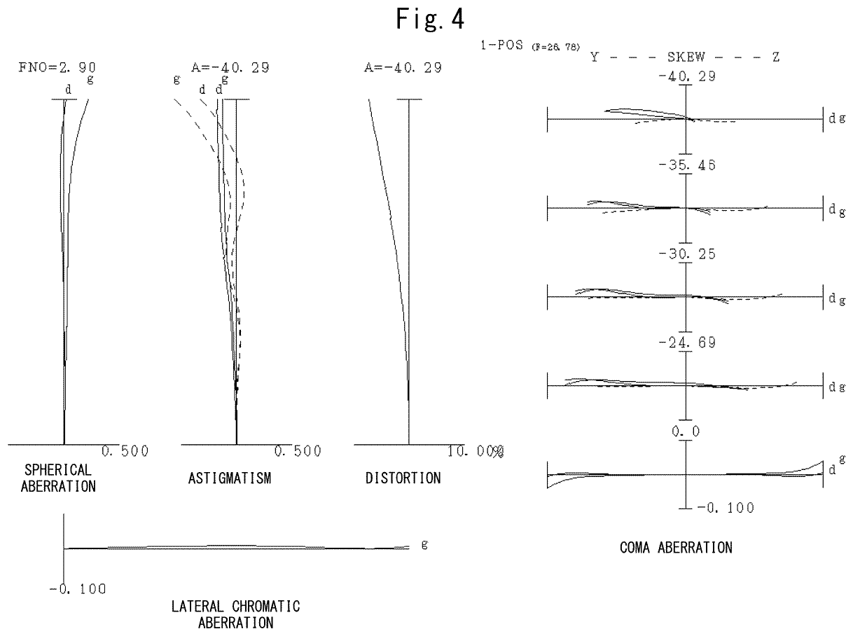

FIG. 4 shows aberrations of the optical system of the second example focusing on an object at infinity.

The graphs of aberrations suggest that the optical system of the present example corrects aberrations appropriately and has high optical performance.

### Third Example

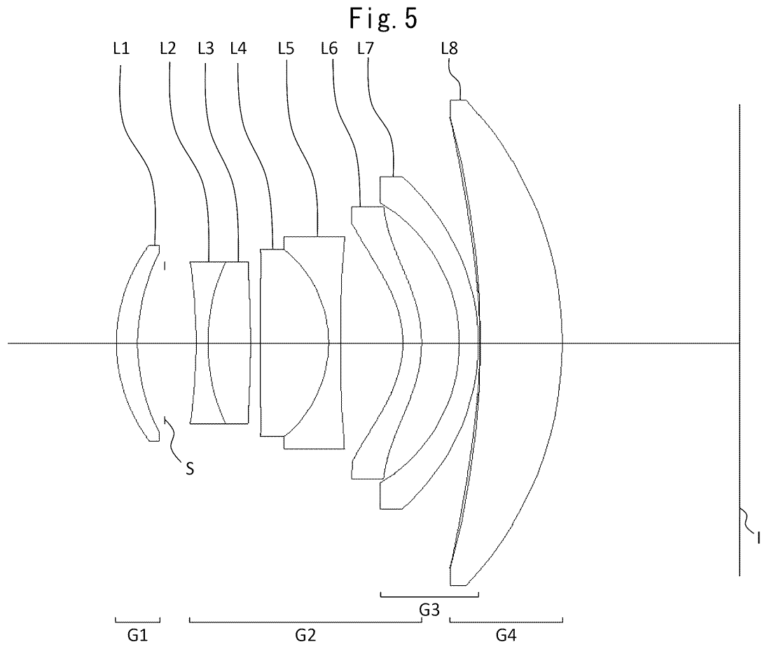

FIG. 5 is a cross-sectional view of an optical system of a third example focusing on an object at infinity.

The optical system of the present example includes, in order from the object side, a first lens group G1 having positive refractive power, an aperture stop S, a second lens group G2 having positive refractive power, a third lens group G3 having negative refractive power, and a fourth lens group G4 having positive refractive power.

The first lens group G1 consists of a meniscus-shaped positive lens L1 convex on the object side.

The second lens group G2 consists of, in order from the object side, a positive cemented lens composed of a biconcave negative lens L2 and a biconvex positive lens L3, a positive cemented lens composed of a biconvex positive lens L4 and a biconcave negative lens L5, and a meniscus-shaped negative lens L6 concave on the object side.

The third lens group G3 consists of a meniscus-shaped negative lens L7 concave on the object side.

The fourth lens group G4 consists of a meniscus-shaped positive lens L8 concave on the object side. The positive lens L8 is configured by providing a resin layer on the object-side surface of a glass lens body. The positive lens L8 is a compound-type aspherical lens in which the object-side surface of the resin layer is aspherical. In [Lens specifications] below, surface number 14 refers to the object-side surface of the resin layer, surface number 15 to the image-side surface of the resin layer and the object-side surface of the lens body (surfaces where the resin layer and the lens body are bonded together), and surface number 16 to the image-side surface of the lens body. The surface having surface number 14 corresponds to the object-side lens surface of the positive lens L8, and the sum of the surface-to-surface distances of surface numbers 14 and 15 corresponds to the central thickness of the positive lens L8.

An imaging device (not shown) constructed from CCD, CMOS, or the like is disposed on an image plane I.

The optical system of the present example focuses by moving the whole optical system along the optical axis. When focus is shifted from infinity to a nearby object, the optical system of the present example moves from the image plane side toward the object side.

In the optical system of the present example, the second, third, and fourth lens groups correspond to the rear group. The positive cemented lens composed of the negative lens L2 and the positive lens L3 corresponds to the first cemented lens, and the positive cemented lens composed of the positive lens L4 and the negative lens L5 corresponds to the second cemented lens.

Table 3 below shows specifications of the optical system of the present example.

TABLE 3
[Lens specifications]

| m | r | d | n(d) | νd |
|---|---|---|---|---|
| *1) | 9.53357 | 1.234 | 1.84737 | 43.7 |
| 2) | 11.38114 | 1.618 | | |
| 3> | ∞ | 1.824 | | (aperture stop) |
| 4) | −32.65502 | 0.700 | 1.59270 | 35.3 |
| 5) | 11.50292 | 2.500 | 1.85108 | 40.1 |
| 6) | −57.90288 | 0.554 | | |
| 7) | 162.74756 | 4.035 | 1.85108 | 40.1 |
| 8) | −7.11488 | 0.700 | 1.70461 | 29.8 |
| 9) | 86.79392 | 3.674 | | |
| 10) | −6.26321 | 1.100 | 1.58286 | 59.5 |
| 11) | −7.61044 | 2.220 | | |
| 12) | −9.63075 | 1.100 | 1.77002 | 31.4 |
| 13) | −12.85267 | 0.100 | | |
| 14) | −35.01849 | 0.050 | 1.56093 | 36.6 |
| 15) | −49.83022 | 4.810 | 1.88300 | 40.7 |
| 16) | −20.81236 | Bf | | |

[Aspherical surface data]

| m | 1) | 6) | 7) | 10) | 11) | 14) |
|---|---|---|---|---|---|---|
| K | 1.0000 | 1.0000 | 1.0000 | 0.7304 | 0.7541 | 1.0000 |
| A4 | −1.27E−05 | 1.09E−04 | 1.24E−05 | 4.58E−04 | 4.96E−04 | 5.10E−05 |
| A6 | 3.13E−07 | 1.33E−07 | −6.29E−07 | 1.28E−05 | 6.00E−06 | −1.80E−07 |
| A8 | −1.19E−08 | −2.59E−08 | −6.17E−08 | 2.27E−08 | 2.18E−07 | 2.62E−10 |
| A10 | 2.87E−09 | −8.22E−09 | | | | |
| A12 | −1.91E−10 | 9.94E−11 | | | | |
| A14 | 3.13E−12 | −3.49E−13 | | | | |

[General specifications]

| | |
|---|---|
| f | 26.78 |
| F. No | 2.90 |
| ω | 40.20 |
| Y | 21.05 |
| TL | 36.68 |

[Focal length data of groups]

| Groups | Starting surfaces | Focal lengths |
|---|---|---|
| G1 | 1 | 53.05 |
| G2 | 4 | 39.61 |
| G3 | 12 | −58.60 |
| G4 | 14 | 44.64 |

[Back focal length]

| | At focusing on infinity | At focusing on a nearby object |
|---|---|---|
| Bf | 10.455 | 15.515 |

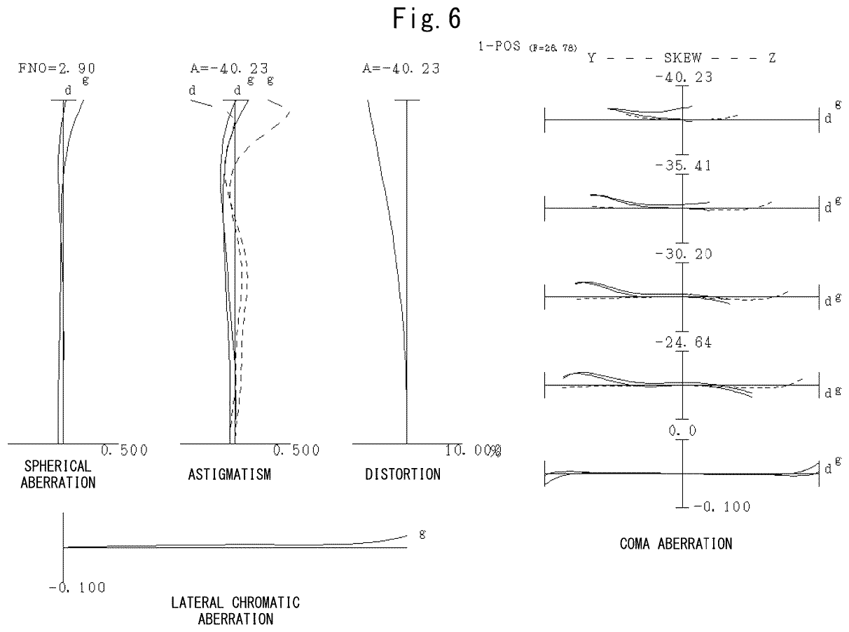

FIG. 6 shows aberrations of the optical system of the third example focusing on an object at infinity.

The graphs of aberrations suggest that the optical system of the present example corrects aberrations appropriately and has high optical performance.

### Fourth Example

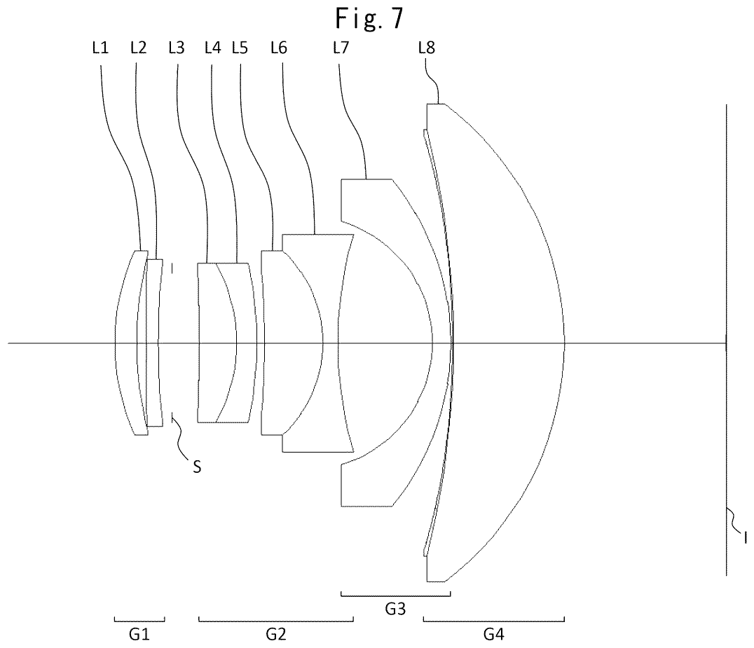

FIG. 7 is a cross-sectional view of an optical system of a fourth example focusing on an object at infinity.

The optical system of the present example includes, in order from the object side, a first lens group G1 having positive refractive power, an aperture stop S, a second lens group G2 having positive refractive power, a third lens group G3 having negative refractive power, and a fourth lens group G4 having positive refractive power.

The first lens group G1 consists of, in order from the object side, a meniscus-shaped positive lens L1 convex on the object side and a meniscus-shaped negative lens L2 convex on the object side.

The second lens group G2 consists of, in order from the object side, a positive cemented lens composed of a meniscus-shaped positive lens L3 concave on the object side and a meniscus-shaped negative lens L4 concave on the object side, and a negative cemented lens composed of a meniscus-shaped positive lens L5 concave on the object side and a biconcave negative lens L6.

The third lens group G3 consists of a meniscus-shaped negative lens L7 concave on the object side.

The fourth lens group G4 consists of a meniscus-shaped positive lens L8 concave on the object side. The positive lens L8 is configured by providing a resin layer on the object-side surface of a glass lens body. The positive lens L8 is a compound-type aspherical lens in which the object-side surface of the resin layer is aspherical. In [Lens specifications] below, surface number 14 refers to the object-side surface of the resin layer, surface number 15 to the image-side surface of the resin layer and the object-side surface of the lens body (surfaces where the resin layer and the lens body are bonded together), and surface number 16 to the image-side surface of the lens body. The surface having surface number 14 corresponds to the object-side lens surface of the positive lens L8, and the sum of the surface-to-surface distances of surface numbers 14 and 15 corresponds to the central thickness of the positive lens L8.

An imaging device (not shown) constructed from CCD, CMOS, or the like is disposed on an image plane I.

The optical system of the present example focuses by moving the whole optical system along the optical axis. When focus is shifted from infinity to a nearby object, the optical system of the present example moves from the image plane side toward the object side.

In the optical system of the present example, the second, third, and fourth lens groups correspond to the rear group. The positive cemented lens composed of the positive lens L3 and the negative lens L4 corresponds to the first cemented lens, and the negative cemented lens composed of the positive lens L5 and the negative lens L6 corresponds to the second cemented lens.

Table 4 below shows specifications of the optical system of the present example.

TABLE 4
[Lens specifications]

| m | r | d | n(d) | νd |
|---|---|---|---|---|
| 1) | 13.45109 | 1.290 | 2.00100 | 29.1 |
| 2) | 21.21240 | 0.591 | | |
| 3) | 2035.86690 | 0.700 | 1.78472 | 25.6 |
| 4) | 48.46055 | 0.798 | | |
| 5> | ∞ | 1.622 | | (aperture stop) |
| *6) | −1428.55530 | 2.259 | 1.85108 | 40.1 |
| 7) | −9.49007 | 1.191 | 1.78472 | 25.6 |
| 8) | −23.19148 | 0.450 | | |
| 9) | −59.94728 | 3.500 | 1.88300 | 40.7 |
| 10) | −7.48584 | 0.900 | 1.59270 | 35.3 |
| 11) | 23.19209 | 5.633 | | |
| 12) | −7.56291 | 1.100 | 1.66382 | 27.4 |
| 13) | −15.31415 | 0.100 | | |
| *14) | −52.50435 | 0.050 | 1.56093 | 36.6 |
| 15) | −52.50435 | 6.616 | 1.88300 | 40.7 |
| 16) | −17.80787 | Bf | | |

[Aspherical surface data]

| m | 6) | 14) |
|---|---|---|
| K | 1.0000 | 1.0000 |
| A4 | −2.16E−04 | −1.19E−05 |
| A6 | 2.74E−06 | 1.34E−08 |
| A8 | −1.55E−07 | −1.59E−11 |
| A10 | 3.48E−13 | |

[General specifications]

| | |
|---|---|
| f | 25.75 |
| F. No | 2.90 |
| ω | 41.70 |
| Y | 20.70 |
| TL | 36.46 |

[Focal length data of groups]

| Groups | Starting surfaces | Focal lengths |
|---|---|---|
| G1 | 1 | 67.07 |
| G2 | 6 | 25.70 |
| G3 | 12 | −23.86 |
| G4 | 14 | 28.00 |

[Back focal length]

| | At focusing on infinity | At focusing on a nearby object |
|---|---|---|
| Bf | 9.655 | 14.259 |

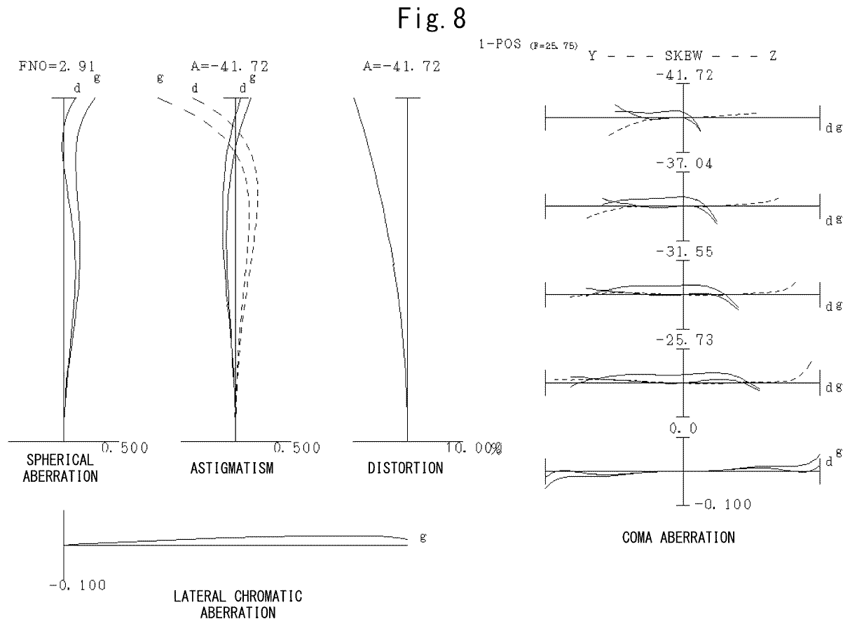

FIG. 8 shows aberrations of the optical system of the fourth example focusing on an object at infinity.

The graphs of aberrations suggest that the optical system of the present example corrects aberrations appropriately and has high optical performance.

### Fifth Example

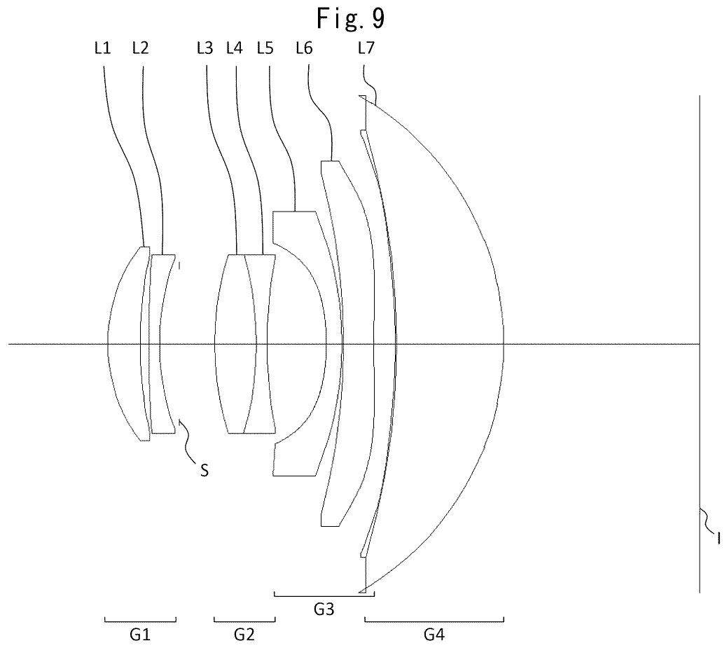

FIG. 9 is a cross-sectional view of an optical system of a fifth example focusing on an object at infinity.

The optical system of the present example includes, in order from the object side, a first lens group G1 having negative refractive power, an aperture stop S, a second lens group G2 having positive refractive power, a third lens group G3 having negative refractive power, and a fourth lens group G4 having positive refractive power.

The first lens group G1 consists of, in order from the object side, a meniscus-shaped positive lens L1 convex on the object side and a meniscus-shaped negative lens L2 convex on the object side.

The second lens group G2 consists of a positive cemented lens composed of a biconvex positive lens L3 and a biconcave negative lens L4.

The third lens group G3 consists of, in order from the object side, a meniscus-shaped negative lens L5 concave on the object side and a biconcave negative lens L6.

The fourth lens group G4 consists of a meniscus-shaped positive lens L7 concave on the object side. The positive lens L7 is configured by providing a resin layer on the object-side surface of a glass lens body. The positive lens L7 is a compound-type aspherical lens in which the object-side surface of the resin layer is aspherical. In [Lens specifications] below, surface number 13 refers to the object-side surface of the resin layer, surface number 14 to the image-side surface of the resin layer and the object-side surface of the lens body (surfaces where the resin layer and the lens body are bonded together), and surface number 15 to the image-side surface of the lens body. The surface having surface number 13 corresponds to the object-side lens surface of the positive lens L7, and the sum of the surface-to-surface distances of surface numbers 13 and 14 corresponds to the central thickness of the positive lens L7.

An imaging device (not shown) constructed from CCD, CMOS, or the like is disposed on an image plane I.

The optical system of the present example focuses by moving the whole optical system along the optical axis. When focus is shifted from infinity to a nearby object, the optical system of the present example moves from the image plane side toward the object side.

In the optical system of the present example, the second, third, and fourth lens groups correspond to the rear group. The positive cemented lens composed of the positive lens L3 and the negative lens L4 is corresponds to the first cemented lens.

Table 5 below shows specifications of the optical system of the present example.

TABLE 5
[Lens specifications]

| m | r | d | n(d) | νd |
|---|---|---|---|---|
| 1) | 10.42781 | 2.079 | 1.78518 | 48.0 |
| 2) | 26.35580 | 0.555 | | |
| 3) | 89.59998 | 0.700 | 1.59270 | 35.3 |
| 4) | 16.01165 | 1.285 | | |
| 5> | ∞ | 2.266 | | (aperture stop) |
| 6) | 19.55988 | 2.668 | 1.90265 | 35.7 |
| 7) | −21.03161 | 0.700 | 1.80809 | 22.7 |
| 8) | 29.74775 | 4.939 | | |
| *9) | −14.09688 | 1.000 | 1.80610 | 40.7 |
| 10) | −21.74529 | 0.106 | | |
| 11) | −42.10327 | 1.947 | 1.58313 | 59.5 |
| *12) | 75.75753 | 1.376 | | |
| *13) | −37.52464 | 0.082 | 1.56093 | 36.6 |
| 14) | −48.69243 | 6.896 | 1.88300 | 40.7 |
| 15) | −18.36826 | Bf | | |

[Aspherical surface data]

| m | 9) | 12) | 13) |
|---|---|---|---|
| K | 1.0000 | 1.0000 | 1.0000 |
| A4 | −6.83E−04 | −3.24E−04 | 1.12E−04 |
| A6 | 4.71E−06 | 3.00E−06 | −1.06E−06 |
| A8 | −4.40E−07 | −2.57E−08 | 2.73E−09 |
| A10 | 1.09E−08 | 8.87E−11 | |
| A12 | −1.88E−10 | | |

[General specifications]

| | |
|---|---|
| f | 31.98 |
| F. No | 2.90 |
| ω | 35.00 |
| Y | 21.70 |
| TL | 37.16 |

[Focal length data of groups]

| Groups | Starting surfaces | Focal lengths |
|---|---|---|
| G1 | 1 | 45.30 |
| G2 | 6 | 39.25 |
| G3 | 9 | −24.08 |
| G4 | 13 | 32.96 |

[Back focal length]

| | At focusing on infinity | At focusing on a nearby object |
|---|---|---|
| Bf | 10.555 | 18.297 |

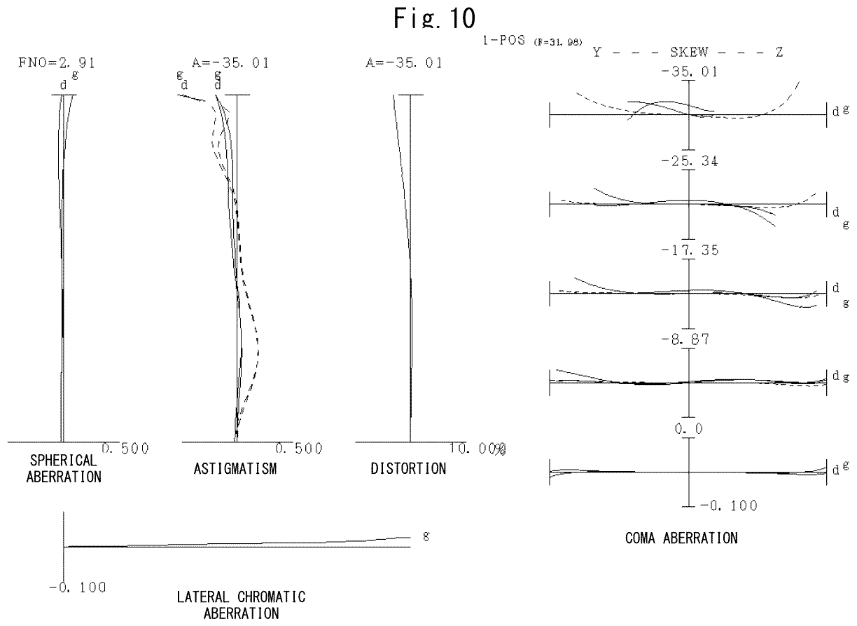

FIG. 10 shows aberrations of the optical system of the fifth example focusing on an object at infinity.

The graphs of aberrations suggest that the optical system of the present example corrects aberrations appropriately and has high optical performance.

An optical system of favorable optical performance can be achieved according to the above examples.

Values for the conditional expressions of the examples are listed below.

Bf is a back focal length in air; y is maximum image height; TL is the distance from a lens surface closest to the object side to an image plane. Np1 and Nn1 are the refractive indices of the positive and negative lenses constituting the first cemented lens, respectively. tp1 and tn1 are the central thicknesses of the positive and negative lenses constituting the first cemented lens, respectively. t1 is the central thickness of a positive lens disposed closest to the object side. vdp1 and vdn1 are the Abbe numbers based on d-line of the positive and negative lenses constituting the first cemented lens, respectively. f is the focal length of the optical system. fc1 is the combined focal length of one of the first and second cemented lenses disposed on the object side; fc2 is the combined focal length of the other of the first and second cemented lenses disposed on the image plane side. Np2 and Nn2 are the refractive indices of the positive and negative lenses constituting the second cemented lens, respectively. vdp2 and vdn2 are the Abbe numbers based on d-line of the positive and negative lenses constituting the second cemented lens, respectively. ΣΔPzi is the total calculated by summing, for each of at least one cemented lens comprising a positive lens and a negative lens and included in the rear group, the Petzval sum of the cemented lens and the inverse of the combined focal length of the cemented lens; ΔPz is the sum of the Petzval sum of the whole optical system and the inverse of the focal length of the optical system. ED is the distance from the lens surface closest to the object side to a lens surface closest to the image plane side. dL1_St is the distance from the lens surface closest to the object side to the aperture stop. TLs is the distance from the aperture stop plane to the image plane. f1, f2, f3, and f4 are the focal lengths of the first, second, third, and fourth lens groups, respectively. D1 is the distance from the lens surface closest to the object side in the first lens group to a lens surface closest to the image plane side in the first lens group. ED is the distance from the lens surface closest to the object side to a lens surface closest to the image plane side. rR1 is the radius of curvature of an object-side lens surface of a lens closest to the image plane side; rR2 is the radius of curvature of an image-plane-side lens surface of a lens closest to the image plane side. tR is the central thickness of the lens closest to the object side. r311 is the radius of curvature of an object-side lens surface of the lens closest to the object side in the third lens group; r312 is the radius of curvature of an image-plane-side lens surface of the lens closest to the object side in the third lens group. d3 is the distance from the aperture stop to the lens surface closest to the object side in the third lens group. dL1_Gr3 is the distance from the lens surface closest to the object side to a lens surface closest to the object side in the third lens group.

[Values for conditional expressions]

| | | Examples | | | | |
|---|---|---|---|---|---|---|
| Conditional expressions | | First | Second | Third | Fourth | Fifth |
| (1) | Bf/y | 0.511 | 0.497 | 0.497 | 0.466 | 0.486 |
| (2) | TL/y | 1.812 | 1.742 | 1.742 | 1.761 | 1.712 |
| (3) | Np1 − Nn1 | 0.290 | 0.290 | 0.258 | 0.066 | 0.095 |
| (4) | tp1/tn1 | 4.000 | 4.160 | 3.571 | 1.897 | 3.811 |
| (5), (8) | f/y | 1.272 | 1.272 | 1.272 | 1.244 | 1.474 |
| (6) | t1/f | 0.047 | 0.039 | 0.046 | 0.050 | 0.065 |
| (7) | νdp1 − νdn1 | 5.400 | 5.400 | 4.800 | 14.500 | 13.000 |
| (8) | fc1/fc2 | 0.706 | 0.678 | 0.918 | −0.019 | |
| (10) | Np2 − Nn2 | 0.196 | 0.166 | 0.146 | 0.290 | |
| (11) | νdp2 − νdn2 | 10.200 | 11.100 | 10.300 | 5.400 | |
| (12) | (ΣΔPzi)/(ΔPz) | 1.062 | 0.990 | 0.866 | 0.880 | 0.589 |
| (13) | ΣD/TL | 0.718 | 0.715 | 0.715 | 0.735 | 0.716 |
| (14) | dL1_St/TL | 0.076 | 0.073 | 0.078 | 0.093 | 0.124 |
| (15) | TL/f | 1.425 | 1.369 | 1.369 | 1.416 | 1.162 |
| (16) | TLs/TL | 0.924 | 0.927 | 0.922 | 0.907 | 0.876 |
| (17) | f1/f | 4.613 | 2.634 | 1.981 | 2.605 | 1.417 |
| (18) | D1/TL | 0.033 | 0.028 | 0.034 | 0.071 | 0.090 |
| (19) | t1/ΣD | 0.046 | 0.040 | 0.047 | 0.048 | 0.078 |
| (20) | (rR2 + rR1)/(rR2 − rR1) | −2.412 | −2.793 | −3.930 | −2.026 | −2.918 |
| (21) | tR/ΣD | 0.242 | 0.231 | 0.185 | 0.249 | 0.262 |
| (22) | (−f3)/f | 0.754 | 0.983 | 2.188 | 0.927 | 0.753 |
| (23) | f4/f | 1.175 | 1.220 | 1.667 | 1.087 | 1.031 |
| (24) | (−f3)/f4 | 0.641 | 0.806 | 1.313 | 0.852 | 0.731 |
| (25) | f2/f | 0.767 | 0.997 | 1.479 | 0.998 | 1.227 |
| (26) | (r312 + r311)/(r312 − r311) | 2.168 | 2.904 | 6.978 | 2.951 | 4.686 |
| (27) | d3/f | 0.603 | 0.589 | 0.646 | 0.604 | 0.331 |
| (28) | dL1_Gr3/ΣD | 0.696 | 0.703 | 0.769 | 0.706 | 0.571 |

The above examples are specific examples of the present invention, and the present invention is not limited thereto. The following details can be appropriately employed unless the optical performance of the optical system of the embodiment of the present application is compromised.

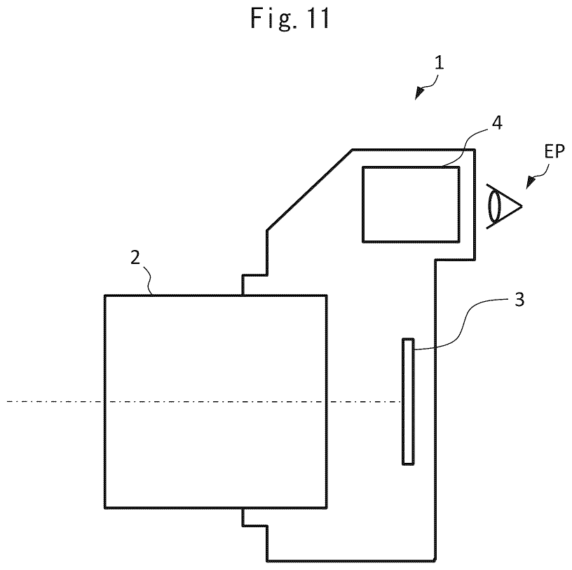

Next, a camera including the optical system of the present embodiment will be described with reference to FIG. 11.

FIG. 11 schematically shows a camera including an optical system of the present embodiment.

The camera 1 is a “mirror-less camera” of an interchangeable lens type including the optical system according to the first example as an imaging lens 2.

In the camera 1, light from an object (subject) (not shown) is condensed by the imaging lens 2 and reaches an imaging device 3. The imaging device 3 converts the light from the subject to image data. The image data is displayed on an electronic view finder 4. This enables a photographer who positions his/her eye at an eye point EP to observe the subject.

When a release button (not shown) is pressed by the photographer, the image data is stored in a memory (not shown). In this way, the photographer can take a picture of the subject with the camera 1.

The optical system of the first example included in the camera 1 as the imaging lens 2 is an optical system of favorable optical performance. Thus the camera 1 can achieve favorable optical performance. A camera configured by including any of the optical systems of the second to fifth examples as the imaging lens 2 can have the same effect as the camera 1.

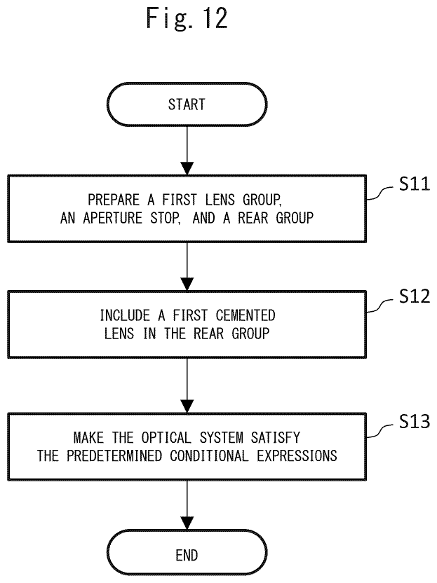

Finally, a method for manufacturing an optical system of the present embodiment will be outlined with reference to FIG. 12. FIG. 12 is a flowchart outlining a method for manufacturing an optical system of the present embodiment.

The method for manufacturing an optical system of the present embodiment shown in FIG. 12 includes steps S11 to S13 below.

Step S11: a first lens group, an aperture stop, and a rear group are prepared.

Step S12: a first cemented lens is included in the rear group.

Step S13: the optical system is made to satisfy the following conditional expressions.

$$0.35 < Bf / y < 0.7 \qquad ( 1 )$$

$$1.35 < TL / y < 2. \qquad ( 2 )$$

$$0.05 < Np 1 - Nn 1 < 0.4 \qquad ( 3 )$$

where
Bf: back focal length in air
y: maximum image height
TL: the distance from a lens surface closest to the object side to an image plane
Np1: the refractive index of the positive lens constituting the first cemented lens
Nn1: the refractive index of the negative lens constituting the first cemented lens

In a modified example, step S23 below may be performed instead of step S13 in the method for manufacturing an optical system shown in FIG. 12.

Step S23: the optical system is made to satisfy the following conditional expressions.

$$0.35 < Bf / y < 0.7 \qquad ( 1 )$$

$$1.35 < TL / y < 2. \qquad ( 2 )$$

$$1.5 < tp 1 / tn 1 < 7. \qquad ( 4 )$$

where
Bf: back focal length in air
y: maximum image height
TL: the distance from a lens surface closest to the object side to an image plane
tp1: the thickness on the optical axis of the positive lens constituting the first cemented lens
tn1: the thickness on the optical axis of the negative lens constituting the first cemented lens

In another modified example, step S33 below may be performed instead of step S13 in the method for manufacturing an optical system shown in FIG. 12.

Step S33: the optical system is made to satisfy the following conditional expressions.

$$1. < f / y < 1.6 \qquad ( 5 )$$

$$0.025 < t 1 / f < 0.08 \qquad ( 6 )$$

where
f: the focal length of the optical system
y: maximum image height
t1: the central thickness of a positive lens disposed closest to the object side

An optical system of favorable imaging performance can be manufactured by these methods for manufacturing an optical system of the present embodiment.

Four-group configurations have been illustrated as examples of the optical system of the present embodiment. However, the present embodiment is not limited to the four-group configurations, and a different group configuration (e.g., a five-group configuration) may be employed. More specifically, the optical system of the present embodiment may be configured by adding a lens or an optical member on the object side or the image plane side of the optical system of one of the examples.

The optical system of the present embodiment may include a vibration reduction lens group configured to make a movement including a component in a direction perpendicular to the optical axis to correct an image blur caused by hand-held camera shake. The vibration reduction lens group may be a lens group or a sub-lens group comprising one or more lens components included in a lens group.

At focusing, the whole optical system, one or more of the lens groups, or a sub-lens group in the optical system of the present embodiment may move in the direction of the optical axis. For example, when focus is shifted from an object at infinity to a nearby object, a lens group disposed closer to the object than the aperture stop and a lens group disposed closer to the image plane than the aperture stop may move toward the object side by different amounts.

In the optical system of the present embodiment, lens surfaces may be spherical, plane, or aspherical surfaces. Spherical or plane lens surfaces are preferable because they facilitate lens machining, assembling, and adjustment and prevent a decrease in optical performance caused by errors in machining, assembling, and adjustment and because depiction performance does not decrease much when the image plane is shifted.

An aspherical lens surface may be formed by grinding glass or glass molding with a mold having an aspherical shape, or formed on the surface of resin bonded on a glass surface. In the optical system of the present embodiment, lens surfaces may be diffractive surfaces, and lenses may be graded index lenses (GRIN lenses) or plastic lenses.

In the optical system of the present embodiment, the aperture stop is preferably disposed between the first and second lens groups. However, without including a separate member serving as the aperture stop, a lens frame or the like may be used as a substitute.

Regarding the above embodiment, the following notes will be further disclosed.

### [Note 1]

The optical system of the present embodiment may satisfy the following conditional expression.

$$3. < vdp 2 - vdn 2 < 30.$$

where
vdp2: the Abbe number based on d-line of the positive lens constituting the second cemented lens
vdn2: the Abbe number based on d-line of the negative lens constituting the second cemented lens

### [Note 2]

The optical system of the present embodiment may satisfy the following conditional expression.

$$0.525 < \sum D / TL < 0.967$$

where
ΣD: the distance from the lens surface closest to the object side to a lens surface closest to the image plane side
TL: the distance from the lens surface closest to the object side to the image plane

### [Note 3]

The optical system of the present embodiment may satisfy the following conditional expression.

$$0.75 < TL / f < 1.6$$

where
TL: the distance from the lens surface closest to the object side to the image plane
f: the focal length of the optical system

### [Note 4]

The optical system of the present embodiment may satisfy the following conditional expression.

$$- 4.5 < ( rR 2 + rR 1 ) / ( rR 2 - rR 1 ) < - 1.5$$

where
rR1: the radius of curvature of an object-side lens surface of a lens closest to the image plane side
rR2: the radius of curvature of an image-plane-side lens surface of a lens closest to the image plane side

It should be noted that those skilled in the art can make various changes, substitutions, and modifications without departing from the spirit and scope of the present disclosure.

What is claimed is:

1. An optical system comprising a first lens group, an aperture stop, and a rear group in order from an object side,
the rear group including a first cemented lens comprising a positive lens and a negative lens,
the optical system satisfying the following conditional expressions.
$$0.35 < Bf / y < 0.7$$
$$1.35 < TL / y < 2.$$
$$0.05 < Np 1 - Nn 1 < 0.4$$
where
Bf: back focal length in air
y: maximum image height
TL: the distance from a lens surface closest to the object side to an image plane
Np1: the refractive index of the positive lens constituting the first cemented lens
Nn1: the refractive index of the negative lens constituting the first cemented lens

2. The optical system according to claim 1, wherein the following conditional expression is satisfied.
$$1.5 < tp 1 / tn 1 < 7.$$
where
tp1: the central thickness of the positive lens constituting the first cemented lens
tn1: the central thickness of the negative lens constituting the first cemented lens

3. An optical system comprising a first lens group, an aperture stop, and a rear group in order from an object side,
the rear group including a first cemented lens comprising a positive lens and a negative lens,
the first lens group including a positive lens disposed closest to the object side,
the optical system satisfying the following conditional expressions.
$$1. < f / y < 1.6$$
$$0.025 < t 1 / f < 0.08$$
where
f: the focal length of the optical system
y: maximum image height
t1: the central thickness of the lens closest to the object side

4. The optical system according to claim 1, wherein the following conditional expression is satisfied.
$$3. < vdp 2 - vdn 2 < 30.$$
where
vdp1: the Abbe number based on d-line of the positive lens constituting the first cemented lens
vdn1: the Abbe number based on d-line of the negative lens constituting the first cemented lens

5. The optical system according to claim 1, wherein the rear group includes a second cemented lens that comprises a positive lens and a negative lens, and that differs from the first cemented lens.

6. The optical system according to claim 5, wherein the following conditional expression is satisfied.
$$1. < f / y < 1.38$$
f: the focal length of the optical system

7. The optical system according to claim 5, wherein, among the first and second cemented lens, one cemented lens disposed on the object side has the negative lens on the object side, and the other cemented lens disposed on the image plane side has the negative lens on the image plane side.

8. The optical system according to claim 5, wherein the following conditional expression is satisfied.
$$- 0.030 < fc 1 / fc 2 < 1.000$$
where
fc1: the combined focal length of one of the first and second cemented lenses disposed on the object side
fc2: the combined focal length of the other of the first and second cemented lenses disposed on the image plane side

9. The optical system according to claim 5, wherein the following conditional expression is satisfied.
$$0.05 < Np 2 / Nn 2 < 0.400$$
where
Np2: the refractive index of the positive lens constituting the second cemented lens
Nn2: the refractive index of the negative lens constituting the second cemented lens

10. The optical system according to claim 1, wherein the following conditional expression is satisfied.
$$0.55 < ( \sum Δ Pzi ) / Δ Pz < 1.400$$
where
ΣΔPzi: the total calculated by summing, for each of at least one cemented lens comprising a positive lens and a negative lens and included in the rear group, the Petzval sum of the cemented lens and the inverse of the combined focal length of the cemented lens
ΔPz: the sum of the Petzval sum of the optical system and the inverse of the focal length of the optical system

11. The optical system according to claim 1, wherein the following conditional expression is satisfied.
$$0.05 < dL 1 \_St / TL < 0.167$$
where
dL1_St: the distance from the lens surface closest to the object side to the aperture stop
TL: the distance from the lens surface closest to the object side to the image plane

12. The optical system according to claim 1, wherein the following conditional expression is satisfied.
$$0.7 < f 1 / f < 5.000$$
where
f1: the focal length of the first lens group
f: the focal length of the optical system

13. The optical system according to claim 1, wherein the following conditional expression is satisfied.
$$0.01 < D 1 / TL < 0.150$$
where
D1: the distance from the lens surface closest to the object side in the first lens group to a lens surface closest to the image plane side in the first lens group
TL: the distance from the lens surface closest to the object side to the image plane

14. The optical system according to claim 1, wherein the following conditional expression is satisfied.
$$0.025 < t 1 / \sum D < 0.080$$
where
t1: the central thickness of the lens closest to the object side
ΣD: the distance from the lens surface closest to the object side to a lens surface closest to the image plane side

15. The optical system according to claim 1, wherein the following conditional expression is satisfied.
$$0.13 < tR / \sum D < 0.350$$
where
tR: the central thickness of a lens closest to the image plane side
ΣD: the distance from the lens surface closest to the object side to a lens surface closest to the image plane side

16. The optical system according to claim 1, wherein the rear group includes, in order from the object side, a second lens group, a third lens group having negative refractive power, and a fourth lens group,
on the object side the third lens group includes a negative meniscus lens disposed closest to the image plane side of negative meniscus lenses concave on the object side that are disposed closer to the image plane than the aperture stop, and
the fourth lens group comprises a positive lens.

17. The optical system according to claim 16, wherein the following conditional expression is satisfied.
$$0.3 < ( - f 3 ) / f < 2.200$$
where
f3: the focal length of the third lens group
f: the focal length of the optical system

18. The optical system according to claim 16, wherein the following conditional expression is satisfied.
$$0.45 < f 4 / f < 2.300$$
where
f4: the focal length of the fourth lens group
f: the focal length of the optical system

19. The optical system according to claim 16, wherein the following conditional expression is satisfied.
$$0.286 < ( - f 3 ) / f 4 < 2.$$
where
f3: the focal length of the third lens group
f4: the focal length of the fourth lens group

20. The optical system according to claim 16, wherein the following conditional expression is satisfied.
$$0.3 < f 2 / f < 2.000$$
where
f2: the focal length of the second lens group
f: the focal length of the optical system

21. The optical system according to claim 16, wherein the following conditional expression is satisfied.
$$1.5 < ( r 312 + r 311 ) / ( r 312 - r 311 ) < 7.000$$
where
r311: the radius of curvature of an object-side lens surface of the lens closest to the object side in the third lens group
r312: the radius of curvature of an image-plane-side lens surface of the lens closest to the object side in the third lens group

22. The optical system according to claim 16, wherein the following conditional expression is satisfied.
$$0.4 < dL1\_Gr3 / \sum D < 0.900$$
where
dL1_Gr3: the distance from the lens surface closest to the object side to a lens surface closest to the object side in the third lens group
ΣD: the distance from the lens surface closest to the object side to a lens surface closest to the image plane side

23. An optical apparatus comprising the optical system according to claim 1.

24. A method for manufacturing an optical system comprising a first lens group, an aperture stop, and a rear group in order from an object side,
the rear group including a first cemented lens comprising a positive lens and a negative lens,
the method comprising disposing lenses so as to satisfy the following conditional expressions.
$$0.35 < Bf / y < 0 \text{.700}$$
$$1.35 < TL / y < 2 \text{.000}$$
$$0.05 < Np 1 - Nn 1 < 0.4$$
where
Bf: back focal length in air
y: maximum image height
TL: the distance from a lens surface closest to the object side to an image plane
Np1: the refractive index of the positive lens constituting the first cemented lens
Nn1: the refractive index of the negative lens constituting the first cemented lens
